(19) United States
(12) Patent Application Publication
(10) Pub. No.: US 2025/0380026 A1
(43) Pub. Date: Dec. 11, 2025

(54) METHOD FOR SETTING RENDITION COUNT, BITRATES, AND RESOLUTIONS FOR TRANSCODING A VIDEO FILE

(71) Applicant: Mux, Inc., San Francisco, CA (US)

(72) Inventor: Justin Greer, San Francisco, CA (US)

(21) Appl. No.: 19/232,625

(22) Filed: Jun. 9, 2025

Related U.S. Application Data
(60) Provisional application No. 63/657,230, filed on Jun. 7, 2024.
(60) Provisional application No. 63/720,450, filed on Nov. 14, 2024.

(51) Int. Cl. H04N 21/4402; H04N 21/433; H04N 21/435; H04N 21/845

(52) U.S. Cl. CPC H04N 21/440263; H04N 21/4331; H04N 21/435; H04N 21/8456

(57) ABSTRACT

A method includes: receiving a video file from a first publisher; partially decoding the video file based on visual characteristics in the video file to generate a proxy video representation of the video file. The method further includes, for a first resolution: accessing a first model associated with the first resolution, the first model configured to derive target bitrates based on resolutions and target viewing qualities; passing the proxy video representation and the source resolution to the first model; and receiving a first target bitrate for the first resolution returned by the first model. The method further includes: defining a first rendition, for the video file, characterized by the first resolution and the first target bitrate; generating an encoding ladder identifying the first rendition; and publishing the encoding ladder for access by a video player for streaming playback segments of the video file.

### CROSS-REFERENCE TO RELATED APPLICATIONS

This application claims the benefit of U.S. Provisional Application No. 63/720,450, filed on 14 Nov. 2024, and U.S. Provisional Application No. 63/657,230, filed on 7 Jun. 2024, each of which is incorporated in its entirety by this reference.

This Application is related to U.S. patent application Ser. No. 16/458,630, filed on 1 Jul. 2019, which is incorporated in its entirety by this reference.

### TECHNICAL FIELD

This invention relates generally to the field of audio and video transcoding and, more specifically, to a new and useful method for just-in-time transcoding with command frames in the field of audio and video transcoding.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

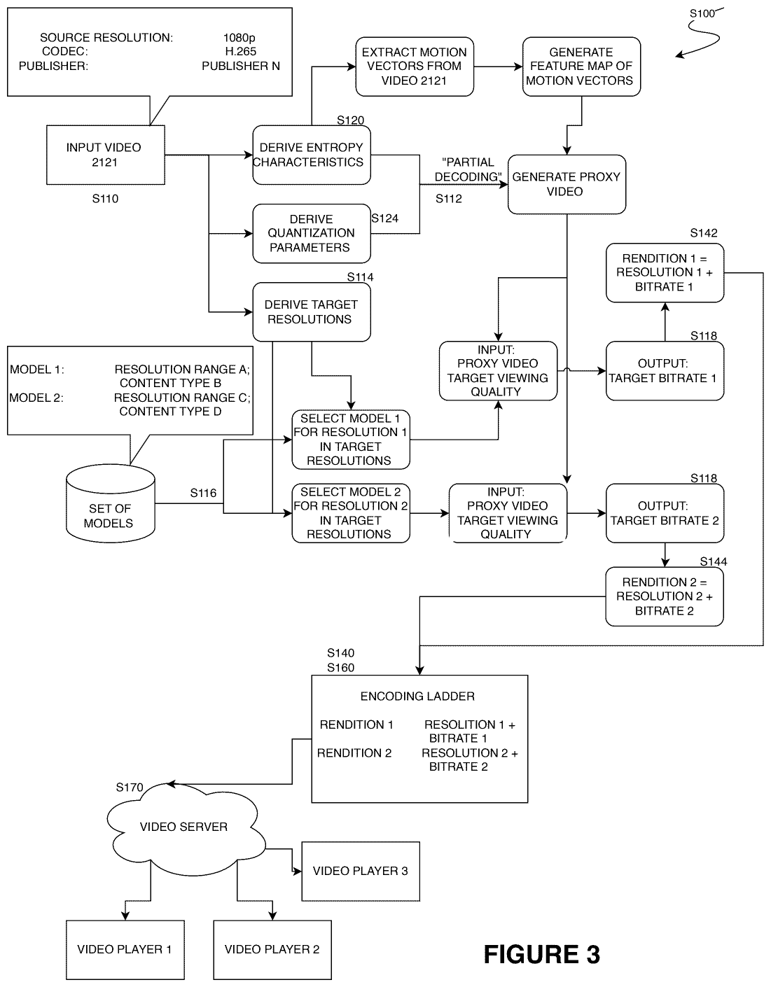

FIG. 4 is a flowchart representation of one variation of the method; and

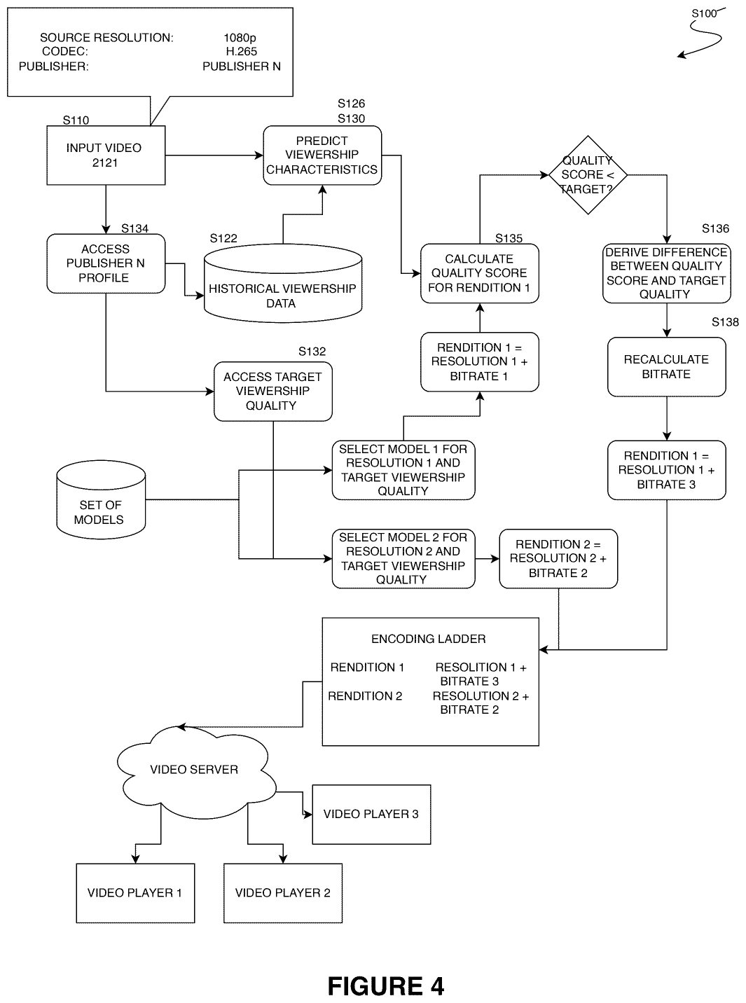

FIG. 5 is a flowchart representation of one variation of the method.

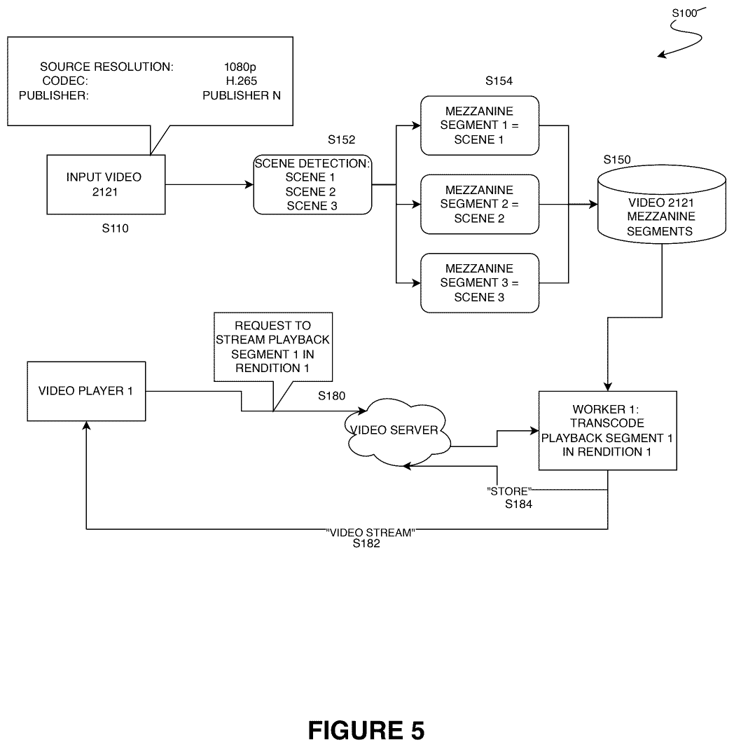

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

As shown in the FIGURES, a method S100 includes: receiving a first video file from a first publisher, the first video file defining a first file size and a source resolution in Block S110; partially decoding the first video file to generate a proxy video representation of the first video file, the proxy video representation defining a second file size less than the first file size in Block S112; and selecting a set of resolutions based on the source resolution in Block S114. The method S100 further includes, for a first resolution in the set of resolutions: accessing a first model associated with the first resolution, the first model configured to derive target bitrates based on target viewing qualities in Block S116; passing the proxy video representation to the first model; and receiving a first target bitrate for the first resolution returned by the first model in Block S118.

The method S100 further includes, for a second resolution in the set of resolutions: accessing a second model associated with the second resolution, the second model configured to derive target bitrates based on target viewing qualities in Block S116; passing the proxy video representation to the second model; and receiving a second target bitrate for the second resolution returned by the second model in Block S118. The method S100 further includes: defining a first rendition for the first video file characterized by the first resolution and the first target bitrate in Block S142; defining a second rendition for the first video file characterized by the second resolution and the second target bitrate in Block S144; generating an encoding ladder identifying the first rendition and the second rendition in Block S160; and publishing the encoding ladder for access by a video player for streaming playback segments of the first video file in Block S170.

### 1.1 Variation: Entropy Characteristics

In one variation, the method S100 includes: receiving a first video file from a first publisher, the first video file defining a first file size in Block S110; deriving a first set of entropy characteristics from the first video file, the first set of entropy characteristics representing visual activity in frames of the first video file in Block S120; and partially decoding the first video file according to the first set of entropy characteristics to generate a proxy video representation of the first video file, the proxy video representation defining a second file size less than the first file size in Block S112. This variation of the method S100 further includes, for a first resolution in a set of resolutions: accessing a first model associated with the first resolution, the first model configured to derive target bitrates based on target viewing qualities in Block S116; passing the proxy video representation to the first model in Block S116; and receiving a first target bitrate for the first resolution returned by the first model in Block S118.

This variation of the method S100 further includes, for a second resolution in the set of resolutions: accessing a second model associated with the second resolution, the second model configured to derive target bitrates based on target viewing qualities in Block S116; passing the proxy video representation to the second model; and receiving a second target bitrate for the second resolution returned by the second model in Block S118. This variation of method S100 further includes: defining a first rendition for the first video file characterized by the first resolution and the first target bitrate in Block S142; defining a second rendition for the first video file characterized by the second resolution and the second target bitrate in Block S144; generating an encoding ladder identifying the first rendition and the second rendition in Block S160; and publishing the encoding ladder for access by a video player for streaming playback segments of the first video file in Block S170.

### 1.2 Variation: Publisher Profiles

Another variation of the method S100 includes: receiving a first video file from a first publisher, the first video file defining a first file size in Block S110; partially decoding the first video file, based on visual characteristics in the first video file, to generate a proxy video representation of the first video file, the proxy video representation defining a second file size less than the first file size in Block S112; accessing a set of historic viewership characteristics for videos published by the first publisher in Block S134; predicting a set of viewer characteristics based on the set of historic viewership characteristics in Block S130; deriving a target viewership quality based on the set of viewer characteristics in Block S132; and selecting a set of resolutions based on the source resolution in Block S114. This variation of the method S100 further includes, for a first resolution in a set of resolutions: accessing a first model configured to derive target bitrates based on target resolutions and target viewing qualities in Block S116; passing the proxy video representation and the first resolution to the first model; and receiving a first target bitrate for the first resolution returned by the first model in Block S118.

This variation of the method S100 further includes, for a second resolution in the set of resolutions: passing the proxy video representation and the second resolution to the first model; and receiving a second target bitrate for the second resolution returned by the second model in Block S118.

This variation of the method S100 further includes: defining a first rendition for the first video file characterized by the first resolution and first target bitrate in Block S142; defining a second rendition for the first video file characterized by the second resolution and the second target bitrate in Block S144; generating an encoding ladder identifying the first rendition and the second rendition in Block S160; and publishing the encoding ladder for access by a video player streaming playback segments of the first video file in Block S170.

### 1.3 Variation: Entropy Characteristics+Quantization Parameters

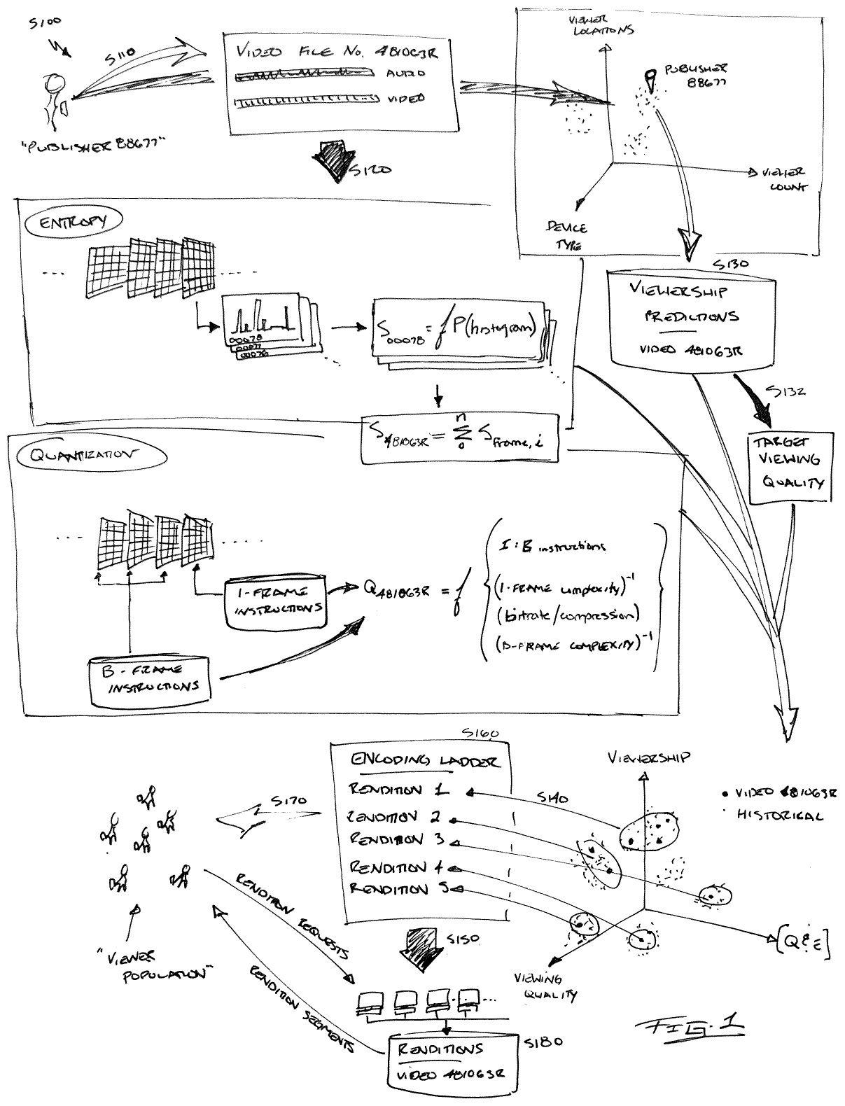

As shown in FIG. 1, one variation of the method S100 for setting rendition count, bitrates, and resolutions for transcoding a video file includes: ingesting the video from a publisher in Block S110; deriving a set of entropy characteristics and quantization characteristics of the video based on encoding characteristics extracted from the encoded video in Block S120; predicting a set of viewership data for the video based on characteristics of the publisher in Block S130; setting a target video viewing quality of the video based on the set of viewership data and/or customer preference in Block S132; based on the set of entropy characteristics and quantization characteristics of the video, generating a count of renditions and bitrate-resolution pairs of renditions in the count of renditions predicted to support viewing qualities, greater than the target video viewing quality, for viewers in a population of viewers viewing renditions of the video in Block S140; segmenting the video into a set of mezzanine segments in Block S150; generating an encoding ladder specifying bitrates and resolutions of renditions in the count of renditions and resource locations of rendition segments transcoded from the set of mezzanine segments in each rendition in Block S160; publishing the encoding ladder for the video in Block S170; and transcoding mezzanine segments according to bitrate-resolution pairs of renditions in the count of renditions in Block S180.

### 1.4 Variation: Predicting Encoding Ladder Based on Video Metadata

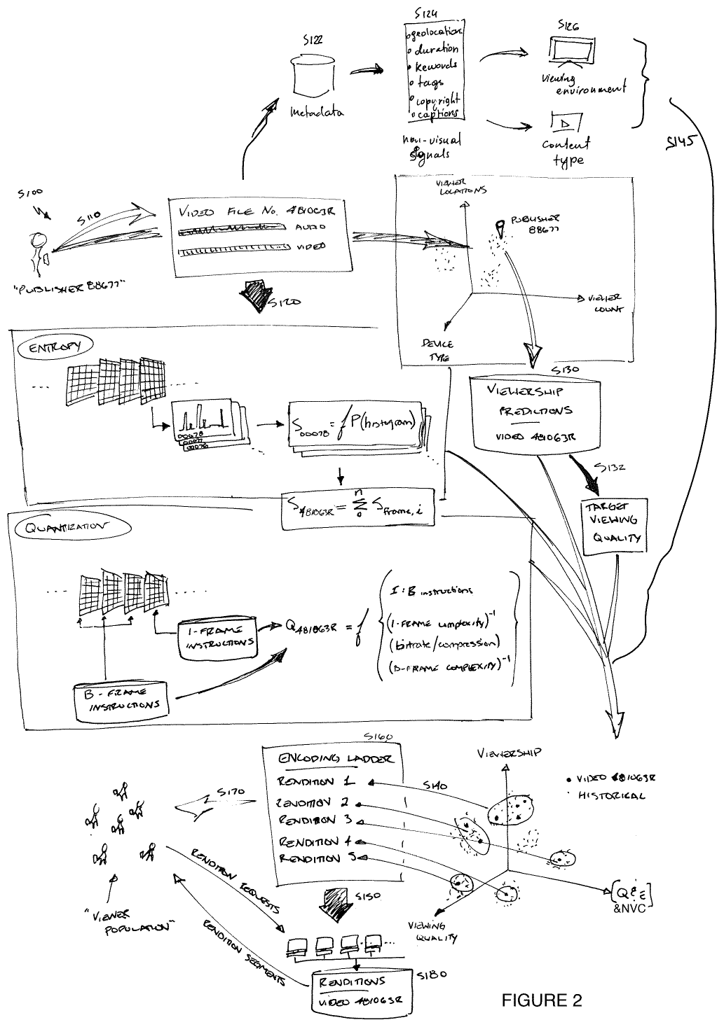

As shown in FIG. 2, a method S100 for setting rendition count, bitrates, and resolutions for transcoding a video includes: ingesting the video from a publisher in Block S110; accessing a set of metadata of the video in Block S122; based on the metadata, identifying a set of non-visual signals of the video in Block S124; based on the set of non-visual signals, predicting a playback environment of the video and deriving a content type of the video in Block S126; accessing a set of historical viewership data for the video in Block S130; setting a target video viewing quality of the video based on the set of viewership data in Block S132; based on the playback environment and the content type, generating a count of renditions and bitrate-resolution pairs of renditions in the count of renditions predicted to support viewing qualities, greater than the target video viewing quality, for viewers in a population of viewers viewing renditions of the video in Block S140; segmenting the video into a set of mezzanine segments in Block S150; generating an encoding ladder specifying bitrates and resolutions of renditions in the count of renditions and resource locations of rendition segments transcoded from the set of mezzanine segments in each rendition in Block S160; publishing the encoding ladder for the video in Block S170; and transcoding mezzanine segments requested by user devices according to bitrate-resolution pairs of renditions in the count of renditions in Block S180.

### 2. Applications

Generally, Blocks of the method S100 can be executed by a computer system—such as a computer network including clustered or distributed workers—in coordination with a content distribution network and/or video players to: ingest a video; derive a proxy video representation of the video; select a set of target resolutions for later playback of the video file, such as based on a source resolution of the video file and/or publisher preference; and set a target viewing quality of playback segments of the video file, such as based on publisher preference and/or viewership history. For each target resolution, the computer system can: select a model in a set of resolution-specific models; pass the proxy video representation, video characteristics (e.g., quantization parameters and/or entropy characteristics), and/or the target viewing quality to the model; and receive a target bitrate—predicted by the model—to yield at least the target viewing quality for a rendition at the target resolution. The computer system can then generate an encoding ladder and/or transcode renditions of the video based on these target bitrate-resolution pairs.

In particular, upon ingest of a video file, the computer system can: derive a proxy video representation by partially decoding the first video file to extract motion vectors and quantization parameters that represent critical visual characteristics, such as motion complexity and compression difficulty, that are most predictive of correlations between bitrate, resolution, and quality; and derive target bitrate-resolution pairs for the video file based on the proxy video representation and without fully decoding the video file.

More specifically, based on the source resolution of the video file, the computer system can: derive a set of target resolutions—for later playback of the video file—representing a minimum count of resolutions, such as only 1080p and 4K; and derive or retrieve a target viewing quality (e.g., VMAF>90), such as based on publisher preference or historic publisher viewership data.

The computer system can then: pass the proxy video representation and target viewing quality to a model, such as a model specifically trained to output 1080p video files containing high-motion content; and receive a target bitrate from the model such that a rendition defined by the target bitrate and the target resolution yields at least the target quality for playback of the video at the rendition.

The computer system can then: define a first rendition based on the target bitrate from the model and the input (or target) resolution characterized by a quality level; and cap a transcoding bitrate at the target bitrate to avoid redundant encoding and computational load.

Therefore, the computer system can reduce computational load of bitrate calculation for a video file—for a particular resolution—that yields at least a target quality for viewers viewing playback of the video file.

In one implementation, the computer system can, for a first video file: partially decode the first video file; extract a set of motion vectors, quantization parameters, and/or frame types; and generate a proxy video representation (e.g., a motion-quantization feature map). The computer system can thus reduce a file size of the video file prior to calculation of the bitrate to thereby: reduce video complexity during model analysis; and reduce computational load of a complete decoding of the video file.

In this implementation, the computer system can additionally derive real-time viewership analytics (e.g., views over time, device types, geolocation, playback quality selection) to validate predicted viewership and accordingly update an encoding ladder for the video file based on this actual viewership data. The computer system can: update the minimum viewing quality for the video over time, such as based on actual viewership data; update the minimum count of renditions and specific bitrate-resolution pairs predicted to yield this updated minimum viewing quality for the current and/or predicted future population of viewers; and update the encoding ladder accordingly. Therefore, the computer system can reuse pretrained models for existing resolutions in real time to thereby avoid re-encoding of removed renditions and maintain a minimum file size of the encoding ladder.

Accordingly, the computer system can selectively extract input signals (entropy features, metadata, viewership) to select a model or a set of target models, for a set of target resolutions necessary for each content type and audience profile, to therefore derive target bitrates and define target renditions, of these target bitrate-resolution pairs, characterized by a target viewing quality.

Therefore, the computer system can minimize a count of models trained to reduce a total computational (e.g., encoding) load, while maintaining derivation of renditions characterized by target quality thresholds.

Generally, a computer system—such as a computer network including clustered or distributed workers—can execute Blocks of the method S100: to ingest an inbound video; to predict both a count and specific bitrate-resolution pairs of renditions predicted to fulfill most (i.e., almost all) viewership expectations for a forecast viewing population by yielding at least a minimum viewing quality of renditions of this video requested by the user population; and publish an encoding ladder-specifying these renditions—for this video.

In particular, the computer system can: extract encoding characteristics and/or pixel data from the video; derive quantization characteristics—that reflect complexity of video—from these encoding characteristics; and calculate entropy characteristics of video based on these pixel data. The computer system can also: predict viewership data for the video, such as view count, viewer locations, and/or viewer device operating systems and connectivity access; and set a minimum (or “target”) viewing quality for viewers of renditions of the video based on these predicted viewership data. For example, this minimum viewing quality can represent a combination of rendition load duration, re-buffering instances and durations, viewer-perceived rendition transitions, viewer-perceived compression artifacts, and video quality (e.g., resolution).

The computer system can then implement a machine learning model, artificial intelligence, or a deterministic function, etc. to transform the quantization and entropy characteristics of the video into a particular count of renditions—and their corresponding bitrate-resolution pairs—predicted to yield the minimum viewing quality when viewed by a predicted population of viewers. The computer system can generate and publish an encoding ladder specifying these renditions for the video and then (selectively) transcode mezzanine segments of the video into rendition segments in these renditions for distribution to viewers.

Therefore, the computer system can implement Blocks of the method S100 to select a minimum count of renditions and the corresponding bitrate-resolution pairs predicted to produce at least a minimum viewing quality of the video for each viewer in a predicted population of viewers for the video. Thus, the computer system can control or limit allocation of computational resources to transcode the video by avoiding generation of additional renditions not necessary to achieve this minimum viewing quality across all viewers.

Furthermore, the computer system (only) derives complexity (e.g., entropy, quantization) characteristics of the video from encoding data, such as based on inter- and intra-frame pixel comparisons and encoding characteristics. The computer system avoids re-encoding the video in a different rendition and directly deriving video quality metrics from this re-encoded video, such as via video multimethod assessment fusion (or “VMAF”) techniques, and thus avoids computationally-intensive, high-latency video characterization processes. The computer system can therefore implement Blocks of the method S100 to rapidly derive complexity characteristics of the video without slow and resource-intensive video re-encoding and direct quality processing.

Additionally, or alternatively, the computer system accesses metadata of the video. Based on the metadata, the computer system then predicts the content type (e.g., lecture slides, high motion content, short-form social media content) of the video and the (most probable) playback environment (e.g., mobile application, high-resolution display, webpage embedding) for the video across the predicted population of viewers. Based on correlations between historic publisher data and corresponding content types and playback environments derived from historic metadata, the computer system further predicts a minimum count of renditions and their specific bitrate-resolution pairs that fulfill most (e.g., almost all, 95%) viewership expectations for a forecast viewing population by yielding at least a minimum viewing quality of renditions of this video requested by the user population. For example, based on the metadata, the computer system can predict the minimum specific bitrate-resolution pairs that are expected to exceed bitrates and resolutions of playback segments requested by most (e.g., 95%) user devices or requested in most (e.g., 95%) requests.

Thus, the computer system can execute Blocks of the method to avoid decoding the video, processing pixel data contained in frames of the video, and other high-latency video characterization processes when predicting the playback environment and the content type of the video. The computer system can therefore implement Blocks of the method S100 to rapidly—and with limited computational resources—derive a minimum (or limited) count of renditions and their specific bitrate-resolution pairs while avoiding high-latency and resource-intensive processes of video re-encoding and direct video quality derivation.

The computer system can also: segment the video into mezzanine segments; generate an encoding ladder for these renditions and mezzanine segments; and transcode these mezzanine segments into rendition segments according to these bitrate-resolution pairs, such as in real-time or just-in-time responsive to requests for specific rendition segments from viewers.

Therefore, the computer system can execute Blocks of the method S100 to rapidly characterize a video and isolate a specific count of renditions and their bitrate-resolution pairs predicted to yield at least a minimum viewing quality for a forecast viewer population. The computer system can thus support: rapid publication of an accurate encoding ladder; and real-time or just-in-time transcoding of the video.

### 3. Terms

Generally, the term “stream,” present herein, refers to a bitstream of encoded audio, video, and/or any other data between two devices or computational entities executing on devices (e.g., video/AV players executing on a mobile computing devices), such as an HLS, HDS, or MPEG-DASH stream. The computer system can initiate streams between servers within the computer system, between the computer system and a content delivery network (hereinafter “a CDN”), and/or between the computer system and any other computational device.

Generally, the term “segment,” present herein, refers to a series of encoded audio and/or encoded video data spanning a discrete time interval, such as a consecutive series of frames in a video file or AV stream (hereinafter the “video stream”).

Generally, the term “mezzanine,” present herein, refers to a compressed master video file that supports transcoding in additional compressed video streams and video files (or “renditions,” downloads). For example, a mezzanine can include a highest-quality (e.g., high bitrate and high resolution) encoding (i.e., a bitrate resolution pair) of a video file cached by the computer system and derived from an original version of the video file uploaded to the computer system. In this example, a “mezzanine segment” can refer to a segment of a video file encoded at a highest-quality encoding for the video file.

Generally, the term “rendition,” present herein, refers to an encoding of a video file indicated in a rendition manifest or manifest file (e.g., an HLS manifest) for a stream of the video file. Therefore, a “rendition segment” refers to a segment of the video file transcoded at a bitrate and/or resolution different from a corresponding mezzanine segment. The computer system can transcode a mezzanine segment into multiple corresponding rendition segments in various renditions representing the same time interval in the video file at differing bitrates and resolutions.

Generally, the computer system can interface directly with a video player instance on a local computing device. Alternatively, the computer system can serve a stream of the video file, or playback segments of renditions of the video file, to a content delivery network (hereinafter “CDN”), which can relay the stream of the video file to the video player instance. For ease of explanation, any discussion herein of requests by a video player instance are also applicable to requests by CDNs.

### 4. Video Ingest

Block S110 of the method S100 recites ingesting a video from a publisher in Block S110. Generally, in Block S110, the computer system can access a live video stream or load a stored video file supplied by a publisher.

The computer system can then directly store this video file as a mezzanine file.

Alternatively, the computer system can: receive the video file; normalize and store the normalized video file in a mezzanine format (e.g., a normalized original or root format from which renditions of the video maybe transcodable); and then discard the original video file. In this implementation, the computer system can: decode the video file; implement methods and techniques described below to derive entropy and/or quantization characteristics of the video in Block S120 based on pixels and encoding characteristics decoded from this video file; then re-encode the video file into a mezzanine format; store this mezzanine file; and discard the original video file.

### 5. Video Decoding and Characteristic Extraction

Generally, the computer system can: partially decode a video file based on visual characteristics extracted from the video file to generate a proxy video representation of the video file, such as a proxy video representation defining a second file size less than a first file size of the video file. In particular, the computer system can: analyze the video file for visual (or nonvisual) characteristics prior to decoding; and decode (or compress) the video according to these characteristics.

In one variation, the computer system can: detect a subset of frames, in the set of frames including the video file, the subset of frames defining a set of keyframes for the video file; and generate a proxy video representation including the subset of frames.

In another variation, the computer system can: detect a codec of the video file; and, in response to the codec of the video file corresponding to a target codec, compress the video file to generate a proxy video representation according to the codec.

Block S120 of the method S100 recites deriving a set of entropy characteristics and quantization characteristics of the video based on encoding characteristics extracted from the encoded video. Generally, in Block S120, the computer system can derive complexity characteristics of the video based on pixel and/or encoding characteristics extracted from the encoded video.

### 5.1 Entropy

In one implementation, the computer system estimates entropy of visual features of the video file (or the mezzanine file, specifically), which may be predictive of or proportional to complexity of the video.

In particular, the computer system can characterize a magnitude of randomness or unpredictability in pixel intensity values across frames in the video and store this magnitude as an entropy value for the video (or a set of entropy values for multiple segments of the video).

In this implementation, the computer system can: convert a frame in the video (or the mezzanine file specifically) to grayscale, thereby reducing entropy analysis to a single channel of pixel intensity values; calculate an entropy value for the frame based on the pixel intensity values of the pixels in the frame; and characterize complexity of the frame based on (e.g., proportional to) this entropy value.

In one example, the computer system can extract motion vectors representing transitions of blocks of pixels between frames of the video file.

In particular, the computer system can: derive a first set of entropy characteristics from the first video file, the first set of entropy characteristics representing visual activity in frames of the first video file; define a subset of pixels, for each frame in the first video file, based on the first set of entropy characteristics; and generate the proxy video representation of the first video file, the proxy video representation including the subset of pixels and a first set of quantization parameters.

More specifically, the computer system can: ingest a video file defining an interframe codec (e.g., H.264, HEVC); extract a set of motion vectors from the video file; based on the set of motion vectors, characterize average motion between frames for the video file; detect a subset of pixels in a particular frame characterized by a “high” average motion between frames; and generate a proxy video file including the subset of pixels.

In one example, the computer system can partially decode the first video file including: extracting a set of motion vectors from the first video file; extracting a set of quantization parameters from the first video file; generating a feature map representing the set of motion vectors and the set of quantization parameters; passing the proxy video representation, the source resolution, and the feature map to a first model; and passing the proxy video representation, the source resolution, and the feature map to the second model.

More specifically, the computer system can: extract a set of motion vectors from inter-coded frames in the video file, the set of motion vectors representing high forward motion in a set of macroblocks indicating rapid scene movement; and extract a set of quantization parameters (e.g., averaging 34) for each macroblock in each frame, the set of quantization parameters representing a “heavy” compression. The computer system can then generate a feature map for the proxy video representation, the feature map including, for each frame in the set of frames: a frame type (e.g., i-frame, p-frame, b-frame); a subset of motion vectors; and/or a subset (or average) of quantization parameters.

In the foregoing example, the computer system can accordingly generate an encoding ladder including the feature map. Then, in response to receiving a first request for a first playback segment of the first video file in the first rendition from a video player, the computer system can: access the feature map from the encoding ladder; initiate transcoding of the first playback segment, in the set of mezzanine segments, into the first rendition by a first worker based on the feature map; initiate a first stream of the first playback segment from the first worker to the video player; and store the first playback segment in the first rendition in a rendition cache.

The computer system can repeat this process for each frame or a subset of frames (e.g., keyframes) in the video (or the mezzanine file specifically). The computer system can also: calculate an average or composite entropy across all frames or across this subset of frames in the video; and characterize a complexity of the entire video based on (e.g., proportional to) this average or composite entropy.

In one variation, the computer system can implement methods and techniques described herein to derive entropy characteristics for a subset of frames (e.g., keyframes) in a particular video, and generate a proxy video representation based on these entropy characteristics. In particular, in this variation, the computer system can: identify a set of keyframes in the first video, the set of keyframes including a first keyframe and a second keyframe; derive a set of entropy characteristics representing visual activity in frames in a set of frames between the first keyframe and the second keyframe; select a set of pixels from the set of frames based on the set of entropy characteristics; and partially decode the first video to generate the proxy video representation including the set of pixels. More specifically, in this variation, the computer system can assemble subsets of pixels, representing visual changes between frames, into a second set of frames to generate the proxy video representation.

Accordingly, the computer system can partially decode the video file based on extracting entropy characteristics representing visual complexity of the video file to thereby efficiently compress appropriate portions of the video file for later processing, including model derivation of bitrate-resolution pairs.

Additionally or alternatively, the computer system can: implement methods and techniques described below to segment the mezzanine file into mezzanine segments in Block S150; and characterize an entropy or complexity of each mezzanine segment in the mezzanine file based on entropy values of frames in these mezzanine segments. Similarly, the computer system can: implement methods and techniques described below to derive quantization characteristics of the video; identify discrete scenes in the video based on similar entropies and/or similar quantization schema of consecutive frames in the video; and characterize an entropy or complexity of each scene in the video based on entropy values of frames corresponding to these scenes.

### 5.2 Quantization Parameters

The computer system can also: extract encoding characteristics from the encoded video (or the mezzanine file specifically); estimate a magnitude of raw data discarded from the video; and derive quantization-based complexity characteristic of the video based on this magnitude of data discard.

For example, during encoding, a codec may segment a frame into blocks (e.g., 16×16-pixel squares) and generate intra-coded frame (or “I-frame”) instructions for setting pixel values in one block in the frame based on pixel values in another block in the frame. In another example, the codec may: select a set of reference frames; and generate predicted and bi-directional predicted (“P- and B-frame”) instructions for encoding differences between a current frame, a reference frame, and/or preceding and succeeding frames. In particular, the codec may: define transfer of blocks from one frame (e.g., a reference frame) in the video to a nearby (e.g., next) frame in the video with a change in position (i.e., motion) of these transferred blocks controlled by a motion vector; and encode these instructions into the video file (i.e., a compressed video stream).

In the foregoing example, the computer system can: detect a first codec associated with the first video file; access a target codec associated with the first publisher, the target codec including an interframe codec; in response to deviation of the first codec from the target codec, transcode the first video file into the target codec; and store the first video file, defined by the target codec, as a mezzanine file associated with the first video file.

Additionally or alternatively, the computer system can: detect a first codec (e.g., H.265, HEVC) associated with the first video file; derive a target codec (e.g., H.264, AVC) associated with the first target bitrate for the first resolution; in response to deviation of the first codec from the target codec, transcode the first video file into the target codec; and store the first video file, defined by the target codec, as a mezzanine file associated with the first video file.

Accordingly, the computer system can reencode ingested videos according to a target (or optimal) codec such that, in response to receiving playback requests from video players, the computer system can decode the video according to a codec, aligning with the compression values (or entropy characteristics) and target quantization parameters, just-in-time to generate playback segments and transmit these playback segments to video players. Therefore, the computer system can re-encode ingested videos into target codecs to normalize processing, such as transcoding playback segments and/or passing video representations to models.

Therefore, the computer system can: extract the encoding characteristics from the encoded video; derive quantization-based complexity characteristics of the video from these encoding characteristics without re-encoding the video into other renditions (or “formats”) and directly characterizing complexity of these particular renditions. In one implementation, low complexity of I-frame encoding characteristics for a frame (e.g., depicting a vibrant city scene) in the video may indicate that a small volume of raw data was discarded from the frame, which may indicate low compression efficiency. In this example, pixel values in one block in the frame may not be predictive of pixel values in other blocks in the frame. Accordingly, the computer system can predict a high complexity of this frame.

In another example, high complexity of I-frame encoding characteristics for a frame (e.g., depicting only calm ocean waves) in the video may indicate that a large volume of raw data was discarded from the frame, which may indicate high compression efficiency. In this example, pixel values in one block in the frame may be predictive of pixel values in other blocks in the frame. Accordingly, the computer system can predict a low complexity of this frame.

In another example, high-complexity P- and/or B-frame instructions with null- or low-velocity motion vectors for a sequence of frames (e.g., depicting an animation or talking head over a static background with limited motion within a scene) in the video may indicate that a large amount of raw data was discarded from these frames, which may indicate high compression efficiency. Accordingly, the computer system can predict a low complexity of the video or a particular scene depicted across these frames.

Similarly, high-complexity P- and/or B-frame instructions with higher-velocity motion vectors for a sequence of frames (e.g., depicting a moving background with some motion within a scene, such as characters walking along city sidewalk with solid-colored building in background) in the video may indicate that a moderate amount of raw data was discarded from these frames, which may indicate high compression efficiency. Accordingly, the computer system can predict a moderate complexity of the video or a particular scene depicted across these frames.

Similarly, low-complexity P- and/or B-frame instructions for a sequence of frames (e.g., depicting characters running through vibrant and dynamic city street) in the video may indicate that a small amount of raw data was discarded from these frames, which may indicate low compression efficiency. Accordingly, the computer system can predict a high complexity of the video or a particular scene depicted across these frames.

In another example, a high ratio of complex I-frame instructions to complex P- and B-frame instructions within the video may indicate that a large amount of raw data was discarded from I-frames but not P- and B-frames. Accordingly, the computer system can predict low intra-frame complexity and high inter-frame complexity, which correspond to a high frequency of pixel value changes not corresponding to motion in a uniform direction between consecutive frames, such as a sequence of frames depicting calm ocean waves.

Furthermore, motion vectors in P- and/or B-frame instructions may represent dynamism of a scene within the video file. In one example, P- and/or B-frame instructions for a sequence of frames define multiple motion vectors, including: a first motion vector for a first set of blocks in the reference frame; and a second motion vector for a second set of blocks in the reference frame. In this example, the first set of blocks spans a (much) larger area than the second set of blocks. Accordingly, the computer system can predict that the first set of blocks correspond to a background and that the second set of blocks correspond to a character or primary visual object in a scene. The computer system can therefore predict that these P- and/or B-frame instructions correspond to: a sequence of frames depicting a scene background in motion (e.g., due to camera motion) based on the first motion vector; and a character or primary visual object moving within the scene based on the second motion vector.

Therefore, for a complex I-frame instruction in the encoded video, the computer system can predict high compression efficiency of the corresponding frame, which may correspond to a simple scene or a scene with a high frequency repeating visual elements; and vice versa.

For complex P- and B-frame instructions in the encoded video, the computer system can interpret a high predictive capacity of reference frames in the video and predict high compression efficiency across the corresponding sequence of frames in the video, which may correspond to a small magnitude of background (and foreground) changes across these frames; and vice versa.

Furthermore, the computer system can predict size and velocity of objects moving within a scene and/or motion of background (e.g., due to camera motion) based on motion vectors in P- and B-frame instructions in the encoded video-rather than directly detecting objects in these frames.

Therefore, the computer system can derive complexities of individual frames, sequences of frames, and/or the entire video based on quantities of data discarded within and between frames in the video (e.g., specifically the mezzanine file), as indicated in I-, P-. and/or B-frame instructions extracted from the encoded video file. The computer system can also interpret types, scales (i.e., sizes), and motions of objects and scenes depicted in the frames based on relative quantities of data discarded from individual frames and recreated based on data in the same frame versus nearby frames in the video.

### 6. Video Metadata Analysis

Blocks S122, S124, and S126 of the method S100 recite: accessing a set of metadata of the video; extracting a set of non-visual signals of the video based on the metadata; and, based on the set of non-visual signals, predicting a playback environment (e.g., video player, mobile application, webpage embedding) of the video and a content type (e.g., presentation slides, short-form social media content, videoconferencing call recording) of the video. Generally, in Block S122, the computer system can retrieve the set of metadata descriptive of the video. More specifically, the computer system can retrieve the metadata that includes characteristics of the video not derived from the pixel content of the video frames. The computer system can access the set of metadata including: descriptive metadata (e.g., title, author, description, keywords, tags); structural data (e.g., relationship between video files and associated subtitle files); administrative metadata (e.g., file type, permissions, creation date, modification data, file size, copyright information); geolocation metadata (e.g., geopositioning coordinates of creation location); subtitle metadata (e.g., SRT or VIT files containing captions or subtitles for the video); and/or audio metadata (e.g., sampling frequency of the audio, language of the audio track). Therefore, the computer system can directly access certain characteristics of the video, contained in the metadata of the video file, without decoding or processing the pixel content of the video frames in the video.

Generally, in Blocks S124 and S126, the computer system can extract target information (e.g., the set of non-visual signals)—indicative of the context of the video and the type of content of the video—from the set of metadata. Based on the target information, the computer system can then predict the intended playback environment of the video and the content type of the video. More specifically, the computer system can extract, from the metadata, the set of non-visual signals including: geolocation of the video, presence of subtitles in the video, density of subtitles in the video, keywords or tags associated with the video, and/or copyright information associated with the video, etc. Then, based on the non-visual signals, the computer system can: predict the intended playback environment for the video, such as a mobile application, a webpage embedding, a browser window, or a large high-resolution screen; and predict the content type of the video, such as a videoconferencing call recording, a presentation containing slides, a video containing text, short-form social media post, long-form social media post, high-motion content, etc. Then, based on the playback environment and the content type, the computer system can generate the range of bitrates for streaming the video. Therefore, based on the metadata, the computer system can predict the intended playback environment for the video and the type of content, and link the playback environment and the content type to a range of bitrates predicted to yield at least the minimum target viewing quality of the video.

In one example, the computer system can: extract the set of non-visual signals including a first geolocation and a first duration of the video based on the metadata, the first geolocation corresponding to a university campus and the first duration corresponding to one hour; and, based on the first geolocation and the first duration, predict that content type includes a video recording of a university lecture, and predict that the playback environment for the video is a browser window. The computer system can: detect a correlation between university lecture recordings and a first set of rendition parameters within sets of historical publisher data and historical metadata. For example, the computer system can correlate the university lecture recording with a first set of rendition parameters characterized by low bitrates (e.g., 1 Mbps to 2.5 Mbps at 1080p resolution) within a narrow range, as university lecture recordings are typically characterized by low-motion content. Accordingly, the computer system can derive the first set of rendition parameters predicted to yield at least the minimum target viewing quality of the university lecture recording.

In a second example, the computer system can extract the set of non-visual signals from the set of metadata, including: a second geolocation corresponding to a cultural landmark; and a second duration of two minutes. Then, based on the second geolocation and the second duration, the computer system can predict that content type of the video includes a short-form social media post and predict that the playback environment for the video will be a mobile application on a mobile device. The computer system can then: access a (previously-derived) correlation between short-form social media content and a second set of rendition parameters within sets of historical publisher data and historical metadata. For example, the computer system can correlate the short-form social media content with a second set of rendition parameters including a second range of bitrates (e.g., 4 Mbps to 6 Mbps at 1080p resolution, higher bitrate range), exceeding the first range of bitrates, as the short-form social media content may contain high-motion content. Accordingly, the computer system can derive the second range of bitrates predicted to yield at least the minimum target viewing quality of the video for the short-form social media video.

In a third example, the computer system can: extract the set of non-visual signals—including a first keyword corresponding to “basketball” and a second keyword corresponding to “highlights”—from the keyword data record (e.g., field) in the set of metadata; and, based on the first keyword and the second keyword, predict that the content type is a sports broadcast and predict that the playback environment for the video is a high-resolution display. The computer system can then: access a (previously-derived) correlation between sports broadcast recordings and a third set of rendition parameters within sets of historical publisher data and historical metadata. For example, the computer system can correlate the sports broadcast recording with a third set of rendition parameters including a third range of bitrates (e.g., 15 Mbps to 25 Mbps at 2160 p resolution, highest bitrate range), exceeding the second range of bitrates, as sports broadcasts are characterized by variable and high motion content and complex visuals and are typically displayed at high resolutions. Accordingly, the computer system can derive the third range of bitrates predicted to yield at least the minimum target viewing quality of the video for the sports broadcast recording.

In response to receiving a (new) ingested video, the computer system can implement methods and techniques described herein to: derive a proxy video representation of the video; derive a content type of the video based on this proxy video representation; and select a model, from the set of models, corresponding to the content type of the video.

Additionally or alternatively, the computer system can: ingest a set of videos from a set of publishers, each video associated with a set of metadata including a content type tag, a publisher identifier, and/or non-visual data (e.g., title and description, language, geographic region); cluster videos in the set of videos based on these metadata; derive a first model for predicting target bitrates (e.g., for a particular resolution) for a first cluster of videos, such as a first cluster of videos defined by fast motion, HUD overlays, and/or frequent scene changes; and derive a second model for predicting target bitrates (e.g., for a particular resolution) for a second cluster of videos, such as a second cluster of videos defined by low-motion (e.g., talking-head content) and/or high quantization parameters. Then, in response to receiving a second video file, the computer system can assign this second video file to a cluster based on metadata associated with the second video file; and implement methods and techniques described herein to pass a proxy video representation of the second video file to a target model and receive a target bitrate from the model.

### 6.1 Deriving Bitrate Ladder Based on User Feedback

In one implementation, the computer system can prompt the user associated with the publisher device to provide contextual information associated with the video. More specifically, in response to accessing the video, the computer system can prompt the user associated with the publisher device to select the playback environment and the content type from a menu of options. For example, the user may select, from the dropdown menu, in the instance of the video player executing on the publisher device, the intended playback environment for the video and the content type of the video. The computer system can access these selections from the instance of the video player and, based on these selections, derive the range of bitrates predicted to yield the target viewing quality of the video. Therefore, the computer system can avoid predicting the playback environment for the video and content type of the video based on the video metadata, which may not be accurate. The computer system can eliminate the computational cost of processing the video metadata and eliminate the risk of inaccurate prediction by prompting the user to select the intended playback environment for the video and the content type of the video in the menu options provided to the user through the video player.

### 7. Publisher Profiles+Viewership Data

Generally, the computer system can: access a publisher profile; extract publisher characteristics; and derive target qualities based on these publisher characteristics. In particular, a publisher profile can include: a set of publisher characteristics, such as target viewing quality (e.g., determined by subscription package and/or publisher status); and a set of historical viewership data associated with videos published by the publisher.

Generally, in Block S130, the computer system can retrieve historical viewership data for the publisher, retrieve historical viewership data for similar videos published by the publisher, or predict viewership data for the video based on historical viewership data of other similar publishers or based on similar videos published by other publishers, etc.

In one implementation, the computer system can: derive target resolutions for a particular video file based on the source resolution of the ingested video; predict viewership for the particular video file based on historical viewership data associated with the publisher; and pass the video file to a model to receive a target bitrate for each resolution in the set of target resolutions based on this predicted viewership for the particular video file.

In particular, in this implementation, the computer system can: receive a first video file from a first publisher, the first video file defining a first file size and a first source resolution; partially decode the first video file, based on visual characteristics in the first video file, to generate a second proxy video representation of the first video file, the first proxy video representation defining a second file size less than the first file size; derive a set of resolutions based on the source resolution; access a publisher profile associated with the first publisher, the publisher profile defining a set of historic viewership characteristics for videos published by the first publisher; predict a set of viewer characteristics based on the set of historic viewership characteristics; and derive a set of target resolutions based on the set of viewer characteristics and the set of resolutions.

The computer system can implement methods and techniques described herein to pass target resolutions, in the set of target resolutions, to derive target bitrates and define target renditions for this video file. The computer system can then: generate an encoding ladder defining the first rendition and the second rendition; and publish the encoding ladder for access by a video player streaming playback segments of the first video file.

In one variation, the computer system can: access a target viewing quality from a first publisher profile associated with the first publisher. Then, for a third resolution in the set of resolutions, during a first time period, the computer system can: access a third model associated with the third resolution, the third model configured to derive target bitrates based on target resolutions and target viewing qualities; pass the proxy video representation and the first set of entropy characteristics to the third model; receive a third target bitrate for the third resolution returned by the third model; calculate a predicted viewing quality associated with the third target bitrate and the third resolution; and, in response to the predicted viewing quality falling below the first target viewing quality, derive a difference between the predicted viewing quality and the target viewing quality. In response to the difference between the predicted viewing quality and the target viewing quality exceeding a threshold difference, the computer system can then: pass the proxy video representation, the first set of entropy characteristics, and the difference between the predicted viewing quality and the target viewing quality to the third model; receive a fourth target bitrate, greater than the third target bitrate, for the third resolution returned by the third model; define a third rendition for the first video file characterized by the third resolution and fourth target bitrate; and annotate the encoding ladder with the third rendition.

In the foregoing variation, the computer system can accordingly: derive target qualities from publisher profiles, such as based on a subscription associated with the publisher or a publisher preference; derive target resolutions based on this target quality; receive target bitrates for resolutions in the set of target resolutions; and recalculate these target bitrates in response to the predicted quality of the bitrate-resolution pair falling below the target quality.

In a similar implementation, the computer system can: derive predicted viewership characteristics for a particular video according to historical viewership data for this publisher and/or content type of the video; and derive target viewership qualities based on the predicted viewership characteristics.

In particular, in this implementation, during a first time period, the computer system can: access a publisher profile, associated with the first publisher, including a set of historic viewership characteristics for videos published by the first publisher; predict a first set of viewer characteristics based on the set of historic viewership characteristics; derive a target viewership quality based on the first set of viewer characteristics; and publish an encoding ladder for access by the video player streaming playback segments of the first video file during the first time period.

In the foregoing implementation, the computer system can rederive updated bitrate-resolution pairs in response to actual viewership data deviating from the predicted viewership data. More specifically, during a second time period, the computer system can: receive a second set of viewer characteristics from the video player, the second set of viewer characteristics representing playback requests received for the first video file at the video player; and calculate a first deviation of the second set of viewer characteristics from the first set of viewer characteristics.

In response to the first deviation of the second set of viewer characteristics from the first set of viewer characteristics exceeding a threshold deviation, for the first resolution in the set of resolutions, the computer system can: access a third model associated with the first resolution, the first model configured to derive target bitrates based on target resolutions and target viewer characteristics; pass the proxy video representation and the second set of viewer characteristics to the third model; and receive a third target bitrate for the first resolution returned by the third model.

Additionally, in response to the first deviation of the second set of viewer characteristics from the first set of viewer characteristics exceeding a threshold deviation, for the second resolution in the set of resolutions, the computer system can: access a fourth model associated with the second resolution, the fourth model configured to derive target bitrates based on target resolutions and target viewer characteristics; pass the proxy video representation and the second set of viewer characteristics to the fourth model; and receive a fourth target bitrate for the second resolution based on the fourth model.

The computer system can then: define a third rendition for the first video file characterized by the first resolution and the third target bitrate; define a fourth rendition for the first video file characterized by the second resolution and the fourth target bitrate; replace the first rendition with the third rendition in the encoding ladder; replace the second rendition with the fourth rendition in the encoding ladder; and republish the encoding ladder for access by the video player for streaming playback segments of the first video file.

In yet another similar implementation, the computer system can: receive a second set of viewer characteristics from the video player, the second set of viewer characteristics representing playback requests received for the first video file at the video player; and calculate a first deviation of the second set of viewer characteristics from the first set of viewer characteristics. In response to the first deviation of the second set of viewer characteristics from the first set of viewer characteristics exceeding a threshold deviation, for the first resolution in the set of resolutions, the computer system can: access a third model associated with the first resolution, the first model configured to derive target bitrates based on target resolutions and target viewer characteristics; pass the proxy video representation and the second set of viewer characteristics to the third model; and receive a third target bitrate for the first resolution returned by the third model.

In response to the first deviation of the second set of viewer characteristics from the first set of viewer characteristics exceeding a threshold deviation, for the second resolution in the set of resolutions, the computer system can: access a fourth model associated with the second resolution, the fourth model configured to derive target bitrates based on target resolutions and target viewer characteristics; pass the proxy video representation and the second set of viewer characteristics to the fourth model; and receive a fourth target bitrate for the second resolution based on the fourth model. The computer system can then: define a third rendition for the first video file characterized by the first resolution and the third target bitrate; define a fourth rendition for the first video file characterized by the second resolution and the fourth target bitrate; replace the first rendition with the third rendition in the encoding ladder; replace the second rendition with the fourth rendition in the encoding ladder; and republish the encoding ladder for access by the video player for streaming playback segments of the first video file.

Accordingly, in the foregoing implementations, the computer system can update bitrate-resolution pairs in an encoding ladder for a particular video based on actual viewership data for playback segments of this video.

In particular, in the foregoing implementations, the computer system can predict viewership data for the video, including: viewership count (i.e., a quantity of devices) requesting rendition segments of the video within a time interval (e.g., a subsequent hour, day, or week); viewership locations (i.e., locations of devices requesting rendition segments of the video within the time interval); and/or device type or operating system of devices requesting rendition segments of the video within the time interval. For example, the computer system can predict these viewership data based on: historical viewership data for videos previously published by the publisher; historical viewership data for similar videos published by the publisher; historical viewership data for videos previously published by other similar publishers (e.g., publishers publishing videos at similar frequencies, on similar topics, of similar lengths, and/or exhibiting similar complexities, qualities, or visual content); and/or historical viewership data for similar videos previously published by other publishers (e.g., prior videos exhibiting similar complexities, qualities, or visual content).

However, the computer system can implement any other method or technique to predict or forecast viewership count (or rate), viewership locations, viewership device characteristics, and/or any other viewership characteristics for the video.

### 7.1 Encoding Ladder+Viewership Data

In one variation, the computer system can: assign a first encoding ladder to a first population of viewers based on the predicted viewership; assign a second encoding ladder to a second population of viewers based on the predicted viewership; evaluate performance of these encoding ladders within the first population of viewers and the second population of viewers; and, in response to a performance of the first encoding ladder falling below a threshold (or target) performance, and in response to a performance of the second encoding ladder exceeding the threshold performance, assign the second encoding ladder to the first population of viewers. Alternatively, in response to a performance of the first encoding ladder falling below a threshold (or target) performance, and in response to a performance of the second encoding ladder exceeding the threshold performance, the computer system can assign the second encoding ladder to (future) videos uploaded by a particular publisher associated with the first video, such as for future videos defining a particular similarity to the first video.

In particular, in this variation, the computer system can: assign the encoding ladder to a first population of video players characterized by a first viewership population; publish the encoding ladder for access by the first population of video players for playback of the first video; generate a second encoding ladder identifying a third rendition, characterized by the first resolution and a third bitrate, and a fourth rendition, characterized by the first resolution and a fourth bitrate, for the first video; assign the second encoding ladder to a second population of video players characterized by a second viewership population; and publish the second encoding ladder for access by the second population of video players for playback of the first video.

Then, following publication of the first encoding ladder and the second encoding ladder, the computer system can: receive (or calculate) a first set of quality scores for playback of the first video from the first population of video players; receive (or calculate) a second set of quality scores, greater than the first set of quality scores, for playback of the first video from the second population of video players; access a first set of metadata for the first video; receive a second video from the first publisher; and access a second set of metadata for the second video. Then, in response to detecting correspondence between the first set of metadata and the second set of metadata, the computer system can: generate a third encoding ladder for the second video, the third encoding ladder identifying the third rendition and the fourth rendition; and publish the second encoding ladder for access by the first population of video players and the second population of video players for playback of the first video.

Accordingly, the computer system can iteratively converge on target encoding ladders, identifying target renditions, according to real-time viewership data and performance of encoding ladders.

### 8. Model Generation

Generally, the computer system can implement machine learning, artificial intelligence, and/or other methods and techniques to generate a set of models configured to derive target bitrates (and/or target bitrate-resolution pairs) based on source resolutions and target viewing qualities.

In particular, the computer system can: access a corpus of videos published by a population of publishers; access a set of renditions, each rendition in the set of renditions comprising a bitrate-resolution pair, available for the corpus of videos; and, for each rendition in the set of renditions, derive a quality score representing quality of playback for video in the rendition. Then, for a first model, the computer system can: select a first subset of videos, in the corpus of videos, characterized by the first resolution and quality scores exceeding a first quality score threshold; and generate the first model based on the first subset of videos. Then, for a second model, the computer system can: select a second subset of videos, in the corpus of videos, characterized by the second resolution and quality scores exceeding the first quality score threshold; and generate the second model based on the second subset of videos.

More specifically, the computer system can ingest: a set of historic videos including original (mezzanine segments) of these videos; and a set of renditions associated with playback of the historic videos, each rendition defining a bitrate-resolution pair. The computer system can then: derive a quality score for each rendition, the quality score representing a quality perceived by a user viewing the video in the rendition; and tag historic videos in the set of historic videos with these quality scores.

The computer system can then: generate proxy video representation for each historic video in the set of historic videos; extract other metadata (e.g., quantization parameters, entropy characteristics, codecs) from these proxy video representations; and input these historical videos tagged with quality scores, proxy video representation, and metadata into a machine learning model with a prompt to train the model on these data to derive correlations between resolutions, bitrates, and quality scores.

In one variation, the computer system can: cluster these historic videos based on resolutions (e.g., resolution ranges); and implement methods and techniques described herein to input these historical videos tagged with quality scores and resolution cluster, proxy video representation, and metadata into a machine learning (or artificial intelligence) model with a prompt to train a set of models on these data, each model configured to derive correlations between bitrates, quality scores, and resolutions in the cluster of resolutions associated with the model.

In a similar variation, the computer system can cluster these historic videos based on content types. In particular, the computer system can: extract target information (e.g., the set of non-visual signals)—indicative of the context of the video and the type of content of the video—from metadata for each video published by a set of publishers; and group clusters of videos and/or publishers in the set of publishers based on content types of these videos. The computer system can then train a set of models based on these groupings. In particular, the computer system can: tag a first set of videos with a first content type (e.g., gaming streams); tag a second set of video with a second content type (e.g., music); train a first model, associated with the first content type, with the first set of videos; and train a second model, associated with the second content type, with the second set of videos.

Accordingly, in this variation, the computer system can: tag a first set of historic videos with a first content type (e.g., gaming streams); tag a second set of historic videos with a second content type (e.g., music); implement methods and techniques as described herein to train a first model, associated with the first content type, with the first set of videos; and implement methods and techniques as described herein to train a second model, associated with the second content type, with the second set of videos.

In one variation, the computer system can generate a vector for each rendition (and mezzanine) of each historic video in the set of historic videos, the vector defining the uniform resource locator to the proxy video representation, bitrate, resolution, quality score, quantization parameters, entropy characteristics, and/or input codec. In this variation, the computer system can evaluate these quality scores against a threshold quality score. In response to a first quality score exceeding the threshold quality score, the computer system can classify the first video associated with the first quality score into a first grouping (e.g., positive class, “1”). In response to a second quality score falling below the threshold quality score, the computer system can classify the second video associated with the second quality score into a second grouping (e.g., negative class, “0”).

The computer system can then: plot these vectors in n-dimensional space; identify clusters of vectors based on the plot of these vectors in n-dimensional space (e.g., proximity-based, density-based); assign a first cluster of vectors to a first model; and assign a second cluster of vectors to a second model.

In one implementation, the computer system can: select a first subset of historic videos for training a model (or set of models); and select a second subset of historic videos for testing the model (or set of models). Then, following training a model associated with a first resolution, the computer system can: pass a first test proxy video representation, from the second subset of historic videos, to the model; receive a first target bitrate from the model; calculate a test quality score for the video according to the first resolution and the first target bitrate; and, in response to the test quality score exceeding the threshold quality score, validate the model.

Accordingly, the computer system can generate a model (or set of models) configured to derive target bitrates for a particular resolution to identify a rendition of a bitrate-resolution pair defining a particular quality based on correlations between historic renditions and quality scores for historic videos ingested by the computer system.

### 8.1 Model Selection

Generally, the computer system can select a model, or a subset of models, for a particular video file based on metadata associated with the video file. In particular, in one example, the computer system can implement methods and techniques described herein to derive a target quality associated with a publisher. The computer system can then: derive a set of target resolutions based on the target quality; and select a subset of models, each model in the subset of models characterized by a target resolution in the set of target resolutions. In one implementation, the computer system can select a first model characterized by a subset of target resolutions in the set of target resolutions, such that the first model can derive target bitrates for a range of resolutions in the set of target resolutions. In the foregoing example, the computer system can derive a target quality associated with a publisher based on content type affiliated with the publisher; and implement methods and techniques described herein to select a subset of models based on the content type and the target quality. In one implementation, the computer system can pre-assign a model or a subset of models to a publisher such that, in response to receiving new videos from the publisher, the computer system can automatically partially decode and process these videos as described herein.

In another example, the computer system can detect a source resolution from the ingested video file. The computer system can then: derive a set of target resolutions based on the source resolution; and select a subset of models, each model in the subset of models characterized by a target resolution in the set of target resolutions. In one implementation, the computer system can select a first model characterized by a subset of target resolutions in the set of target resolutions, such that the first model can derive target bitrates for a range of resolutions in the set of target resolutions.

In yet another example, the computer system can detect a source codec from the ingested video file. The computer system can then: derive a set of target resolutions based on the source codec; and select a subset of models, each model in the subset of models characterized by a target resolution in the set of target resolutions. In one implementation, the computer system can select a first model characterized by a subset of target resolutions in the set of target resolutions, such that the first model can derive target bitrates for a range of resolutions in the set of target resolutions.

Additionally or alternatively, the computer system can: detect a source codec from the ingested video file; in response to the source codec deviating from a target codec, transcode the video file into the target codec; and implement methods and techniques described herein to derive a set of target resolutions based on the target codec and the source resolution.

In one variation, the computer system can leverage predicted viewer and video characteristics to rendition count, bitrates and resolutions, and viewing quality to assign a model (or subset of models) to a particular video file to derive target bitrates associated with target resolutions to thereby derive target renditions (e.g., a minimum count of renditions) for the particular video file. The computer system can later implement this model to calculate a rendition count, bitrates, and resolutions to achieve a minimum viewing quality for a next inbound video.

8.2 Quality vs. Bitrate Thresholds

In one implementation, the computer system can: receive a first target bitrate (e.g., maximum bitrate) from a first model; evaluate the first target bitrate for a target quality in Block S135; and, in response to the first target bitrate associated with a first quality falling below the target quality, recalculate the target bitrate in Block S138.

In particular, in this implementation, the computer system can, for a first resolution and a first model: derive a target quality value (e.g., constant frame rate quality value, structural similarity index measure), associated with a target bitrate output by the first model; and a second bitrate falling below the target bitrate associated with the target quality value. Additionally or alternatively, the computer system can: set the target bitrate as a maximum bitrate value for transcoding of the video file; and derive a first quality value, associated with a target bitrate output by the first model, the first quality value falling below a target quality value. The computer system can then scale the target bitrate to derive a set of target bitrates resulting in the target quality value prior to serving the proxy video representation to a model.

In one example, the computer system can initially pass the proxy video representation to the first model associated with a first running speed (or first cost efficiency). In response to the first model returning a first bitrate, associated with a quality value falling below a threshold quality value, the computer system can select a third model, associated with the first resolution and a second running speed exceeding the first running speed (or second cost efficiency exceeding the first cost efficiency); and implement methods and techniques described herein to pass the proxy video representation to the third model and receive a third target bitrate, exceeding the first target bitrate, from the third model.

Accordingly, the computer system can recalculate target bitrates accordingly in response to resulting viewing qualities falling below a target quality.

### 8.3 Quality Threshold

Block S132 of the method S100 recites setting a target video viewing quality of the video based on the set of viewership data and/or customer preference. Generally, in Block S132, the computer system can set a minimum (or “target”) viewing quality for renditions (or “versions”) of the video viewed by a population of viewers based on predicted or forecast viewership characteristics for the video and/or characteristics of the publisher. Additionally or alternatively, the computer system can set the target video viewing quality to a viewing quality specified by the user.

In particular, the computer system can set a target viewing quality including: a rendition load duration; re-buffering instances and durations; viewer-perceived transitions between renditions of different bitrates and/or resolutions; viewer-perceived compression artifacts within renditions; and/or video quality (e.g., viewer-perceived resolution, clarity, color accuracy, frame rate, and audio fidelity). In Block S132, the computer system can set a minimum (or “target”) viewing quality for views of renditions of the video, which can represent a combination of: a maximum rendition load duration; a maximum quantity and duration of re-buffering instances; a maximum quantity of viewer-perceived transitions between renditions of different bitrates and/or resolutions; a maximum quantity or scope of viewer-perceived compression artifacts within renditions; and/or a minimum video quality (e.g., minimum viewer-perceived resolution, clarity, color accuracy, frame rate, and audio fidelity).

In one example, the computer system can: estimate a viewer quality of a particular video file (e.g., of a particular rendition); and extract a threshold viewer quality from a publisher profile. In this example, the computer system can: extract a first target viewing quality from a set of publisher characteristics (e.g., a publisher profile); access a first model associated with the first resolution, the first model configured to derive target bitrates based on source resolutions and the first target viewing quality; and access a second model associated with the second resolution, the second model configured to derive target bitrates based on source resolutions and the first target viewing quality.

Accordingly, the computer system can select a first model and a second model according to target viewing qualities associated with publisher profiles.

In this implementation, the computer system can: set this minimum viewing quality based on predicted or forecast viewership characteristics for the video and/or characteristics of the publisher. For example, the computer system can set the minimum viewing quality proportional to the forecast count or rate of views of the video, such as by setting: a low minimum viewing quality of “50/100” if ten viewers are forecast; and a high minimum viewing quality of “90/100” if 10,000 viewers are forecast within the same time window.

In another example, the computer system can set the minimum viewing quality proportional to a quantity of viewers following the publisher and/or proportional to an average quantity of viewers of other videos recently published by the publisher, such as by setting: a low minimum viewing quality of “40/100” if the publisher has ten followers or 100 views across its last five video publications; and a high minimum viewing quality of “95/100” if the publisher has one million followers or two million views across its last five video publications.

Generally, the computer system can implement a lookup table, a parametric function, machine learning, or artificial intelligence techniques, etc. to convert these forecast viewership data and/or publisher characteristics, etc. into a minimum viewing quality for the video.

In one implementation, the computer system can: access a first video viewing quality for the video specified by the user; and set the target video viewing quality for the video to the first viewing quality. Additionally or alternatively, the computer system can: access a video content type and/or a playback environment for the video specified by the user; access the first video viewing quality associated with the video content type and/or a playback environment; and set the target video viewing quality for the video to the first video viewing quality.

### 8.3.1 Viewing Quality Prediction

In one implementation, the computer system can predict a viewing quality for a particular target bitrate (e.g., provided by a model) in Block S135. In particular, the computer system can, for a particular resolution in the set of resolutions: access a model associated with the particular resolution, the model configured to: derive target bitrates based on source resolutions and target viewing qualities; pass a proxy video representation of the video file and the source resolution to the third model; receive a third target bitrate for the third resolution returned by the third model; calculate a predicted viewing quality associated with the third target bitrate and the third resolution in Block S135; in response to the predicted viewing quality falling below the first target viewing quality, derive a difference between the predicted viewing quality and the first target viewing quality in Block S136; in response to the difference between the predicted viewing quality and the target viewing quality exceeding a threshold difference, calculate a fourth bitrate, greater than the third bitrate, based on the difference between the predicted viewing quality and the first target viewing quality in Block S138; define a third rendition for the first video file characterized by the third resolution and third target bitrate; and annotate the encoding ladder with the third rendition.

Additionally or alternatively, the computer system can, for a third resolution in the set of resolutions: access a third model associated with the third resolution, the third model configured to derive target bitrates based on source resolutions and target viewing qualities; pass the proxy video representation and the source resolution to the third model; receive a third target bitrate for the third resolution returned by the third model; calculate a predicted viewing quality associated with the third target bitrate and the third resolution; in response to the predicted viewing quality falling below the first target viewing quality, derive a difference between the predicted viewing quality and the first target viewing quality; pass the proxy video representation, the source resolution, and the difference between the predicted viewing quality and the first target viewing quality to the third model; receive a fourth bitrate, greater than the third bitrate, for the third resolution returned by the third model; define a third rendition for the first video file characterized by the third resolution and third target bitrate; and annotate the encoding ladder with the third rendition.

Accordingly, the computer system can recalculate bitrates in response to these bitrates characterizing qualities falling below a target quality.

In one example, the computer system can: access a model characterized by a target resolution (e.g., 1440p); pass the proxy video representation and the source resolution (e.g., 2160×3840) to the model; receive a target bitrate (e.g., 3.8 Mbps) for the target resolution returned by the model; calculate a predicted viewing quality (e.g., VMAF 87) associated with the third target bitrate and the third resolution; in response to the predicted viewing quality falling below the first target viewing quality (e.g., VMAF 90), derive a difference between the predicted viewing quality and the first target viewing quality; repass the proxy video representation, source resolution, and the difference (e.g., 3 quality points) into the model to request a second bitrate, corrected for the difference; and receive the second bitrate (e.g., 4.5 Mbps), greater than the target bitrate, for the target resolution returned by the model, the second bitrate characterized by a predicted quality score (e.g., VMAF 92) greater than the target quality threshold.

Accordingly, in the foregoing implementations, the computer system can: predict viewing quality of target bitrates—received from model and characterizing a particular rendition—and, in response to viewing quality deviating from target viewing quality (e.g., by greater than a threshold difference), recalculate the bitrate, such as by repassing to the model and/or local recalculation by the computer system.

In one variation, the computer system can predict viewership quality by calculating a quality score representing predicted viewership quality of a particular bitrate-resolution pair, defining a particular rendition, prior to publication of the encoding ladder.

In particular, in this implementation, the computer system can: calculate a first quality score for the first video file based on the first file size and the source resolution; calculate a second quality score for the first rendition based on the first target bitrate and the first resolution; and calculate a difference between the first quality score and the second quality score. In response to the second quality score falling below the first quality score and in response to the difference between the first quality score and the second quality score exceeding a threshold difference, the computer system can: access a third model associated with the first resolution, the third model configured to recalculate target bitrates based on target viewing qualities; pass the proxy video representation and the difference between the first quality score and the second quality score to the third model; and receive a third target bitrate for the first resolution returned by the third model.

The computer system can then: define a third rendition for the first video file characterized by the first resolution and the third target bitrate; and annotate the encoding ladder with the third rendition.

In a similar implementation, the computer system can: calculate a first quality score for the first video file based on the first file size and the source resolution; calculate a second quality score for the first rendition based on the first target bitrate and the first resolution; and calculate a difference between the first quality score and the second quality score. The computer system can then define the first rendition for the first video file characterized by the first resolution and the first target bitrate in response to the difference between the first quality score and the second quality score falling below a threshold difference.

Accordingly, in the foregoing implementations, the computer system can: predict viewing qualities of bitrate-resolution pairs; and, in response to these viewing qualities falling below a threshold viewing quality (e.g., defined by the publisher), recalculate the bitrate to derive a second bitrate-resolution pair defined by a second viewing quality exceeding the threshold viewing quality.

### 9. Rendition Selection

Block S140 of the method S100 recites, based on the set of entropy characteristics and quantization characteristics of the video, generating a count of renditions and bitrate-resolution pairs of renditions in the count of renditions predicted to support viewing qualities, greater than the target video viewing quality, for viewers in a population of viewers viewing renditions of the video. Generally, in Block S140, the computer system calculates a specific count of renditions—and their corresponding bitrate-resolution pairs—predicted to yield the minimum viewing quality based on: the complexity of the video; and/or locations, device characteristics, and/or connectivity limitations of predicted viewers.

Block S145 of the method S100 recites, based on the predicted playback environment and content type, generating a count of renditions and bitrate-resolution pairs of renditions in the count of renditions predicted to support viewing qualities, greater than the target video viewing quality, for viewers in a population of viewers viewing renditions of the video. Generally, in Block S145, the computer system calculates a specific count of renditions—and their corresponding bitrate-resolution pairs—predicted to yield the minimum viewing quality based on: the predicted complexity of the video associated with the video content type; and/or predicted device characteristics and/or connectivity limitations of the predicted playback environment, as indicated by the metadata of the video.

### 9.1 Complexity+Video Characteristics

Generally, a video characterized by low complexity (e.g., low entropy) may support more aggressive compression and/or more lossy compression, which may yield lower bitrate requirements, less re-buffering, faster video load times, and less rendition switching during playback without substantial reduction in perceived video quality. Conversely, a video characterized by high complexity (e.g., high entropy) may require less aggressive compression and/or less lossy compression in order to maintain viewing quality, but at the expense of higher bitrate, greater risk of more re-buffering, slower video load times, and/or more frequent rendition switching during playback.

Therefore, the computer system can compensate for a higher-complexity video by generating an encoding ladder specifying availability of more renditions in different bitrates and resolutions, thereby enabling a device: to request a particular rendition—more closely suited to its real-time connectivity limitations—that achieves improved resolution and video quality; and to achieve less discordant rendition hopping and thus a greater viewing quality by transitioning between more renditions with smaller bitrate and resolution steps therebetween responsive to connectivity changes. Conversely, the computer system can achieve sufficient viewing quality of a lower-complexity video despite generating an encoding ladder specifying availability of fewer renditions, thereby reducing a maximum quantity of renditions of the video transcoded for viewers and reducing computational resources allocated to this lower-complexity video.

Furthermore, a population of viewers located primarily or exclusively in an advanced economy or high-income country (e.g., the United States, Finland) may achieve consistent and greater connectivity within a narrow, higher range of bandwidth than a population of viewers located across both advanced and emerging economies and high- and low-income states. Therefore, if the computer system predicts viewership locations predominantly or solely in an advanced economy or high-income country, the computer system can: predict more consistent and greater connectivity within a narrow, higher range of bandwidth for viewers; and thus specify smaller bitrate and/or resolution steps between renditions for the video, thereby enabling devices in this country to switch between renditions with less perceptible video quality changes during playback. Conversely, if the computer system predicts a wide range of viewership locations across both less and more advanced economies or high- and low-income countries, the computer system can: predict less consistent connectivity within a wider range of bandwidths for viewers; and thus specify larger bitrate and/or resolution steps between renditions for the video and/or a greater quantity of renditions, thereby enabling each device in this population to request rendition segments in at least one rendition—in a corresponding bitrate—that is playable under its current connectivity conditions.

For example, if the computer system predicts ten viewers in the United States, the computer system can specify a low count of renditions spanning a narrow, higher range of bitrates. In this example, if the computer system predicts 10,000 viewers across the entire world, the computer system can specify a high count of renditions spanning both a wide range of resolutions and a wide range of bitrates per resolution.

### 9.2 Proximity to Historical Playback Instances

In one implementation, the computer system generates a count of renditions and their target bitrate-resolution pairs—predicted to yield at least the quality threshold for predicted viewers—based on: historical viewership data for other videos; video entropy and quantization characteristics of the video; and connectivity conditions of the predicted viewer population for the video.

In this implementation, the computer system can retrieve historical video viewership data for many playback instances (or “sessions”) of many videos previously viewed across a population of users. For example, for a first playback instance (or “session”) of a prior video, the computer system can access: bitrate-resolution pairs of renditions viewed and/or requested by a device during a playback instance; a video entropy value of the prior video; a quantization value of the prior video; derived characteristics of visual content in the video extrapolated from encoding characteristics (i.e., rather than pixel data); a device location during playback; a bandwidth or connectivity metric of the device during playback; a viewer device type or operating system; a video load time; a count and/or duration of video re-buffering instances during playback; a count and resolution change magnitude of rendition transitions during playback; a magnitude of compression artifacts during playback; and/or a difference between video quality served (e.g., resolution, compression artifacts) and maximum video quality supported at the device given connectivity during playback; etc. For this playback instance, the computer system can then calculate a viewing quality based on: the video load time; the count and/or duration of video re-buffering instances; the count and resolution change magnitude of rendition transitions; the magnitude of compression artifacts; and/or the difference between video quality served and maximum video quality supported. The computer system can then populate a historical vector (or other container) with these data, including: video entropy value; video quantization value; derived characteristics of visual content; viewer location; viewer bandwidth or connectivity metric; viewer device type or operating system; and/or viewing quality; etc. The computer system can also label this historical vector with the bitrate-resolution pairs of renditions requested and/or rendered by the device during this playback instance.

The computer system can: repeat this process for each other playback instance across the set of prior videos to generate a corpus of historical vectors; and store these vectors in a multi-dimensional feature space.

For the target video, the computer system can similarly predict viewership locations, count, bandwidth or connectivity metrics, and/or device characteristics, as described above. The computer system can retrieve the minimum viewing quality, video entropy value(s), derived characteristics of visual content in the video, and quantization value(s) for the target video. The computer system can then: generate a set of target vectors equal to or representing the predicted viewership count; populate these target vectors with corresponding predicted viewership locations, bandwidth access, and/or device and video characteristics; and project these target vectors into the multi-dimensional feature space.

The computer system can then: implement clustering techniques to find groups of historical vectors nearest these target vectors; identify a minimum quantity of historical vector clusters within a threshold distance of (i.e., sufficiently similar to) each target vector; and set this minimum quantity of historical vector clusters as a count of renditions for the target video. The computer system can then: extract minimum, maximum, average, or composite bitrate and resolution pair values from each historical vector cluster in this minimum quantity of historical vector clusters; populate an encoding ladder—for the target video—with specifications for renditions in these bitrates and resolutions; and enable transcoding of mezzanine segments into rendition segments in these renditions according to these bitrates and resolutions.

9.3 Correlations with Content Type, Playback Environment, and Metadata

In another implementation, during an initial time period (e.g., model generation phase) the computer system can: access the metadata and the historical video viewership data for many playback instances (or “sessions”) of various videos previously viewed across a population of users; based on the metadata, extract the playback environment and content type of each session; based on the historical viewership data, identify corresponding bitrate-resolution pairs of renditions viewed and/or requested by a device during each session; and, for each session, correlate the playback environment and content type to the bitrate-resolution pairs of renditions requested. The computer system can then compile these correlations into a model that relates the predicted playback environment and content type to rendition count, bitrates, and resolutions predicted to achieve a minimum viewing quality for a next inbound video. Thus, the computer system can generate a model (e.g., a machine learning model) configured to predict a count of renditions and their bitrate-resolution values for a video based on the predicted viewing environment and content type derived from the metadata of the video.

In this implementation, during a later model application phase, the computer system receives a video in Block S110 and then implements methods and techniques described above to predict the playback environment and derive content type based on the set of metadata associated with the video in Block S126. The computer system also predicts viewer population characteristics (e.g., location, count, device characteristics) for the video in Block S130; and, based on the viewer population characteristics, sets the minimum viewing quality for the target video in Block S132. The computer system then injects these values into the model to calculate rendition parameters—including count of renditions and their bitrate-resolution values—based on the correlations and the minimum viewing quality of target video. The computer system then: populates an encoding ladder—for the target video—with specifications for renditions in these bitrates and resolutions; and assigns these renditions and their bitrates and resolutions to the target video.

Thus, the computer system can: train the model to transform non-visual signals, present in video metadata, directly into a specification for bitrate-resolution pairs of renditions of the video predicted to fulfill viewership expectations (e.g., minimum playback quality) of a forecast viewership population requesting renditions of the video.

In another implementation, during an initial time period (e.g., model generation phase) the computer system can: access the metadata and the historical video viewership data for many playback instances (or “sessions”) of several videos previously viewed across a population of users; and, based on the historical video viewership data for each session, correlate the metadata of the video to the corresponding bitrate-resolution pairs of renditions requested. The computer system can then compile these correlations into a model that directly relates the metadata of a video to rendition count, bitrates, and resolutions predicted to fulfill viewership expectations (e.g., minimum playback quality) of a forecast viewership population requesting renditions of the video. Thus, the computer system can forgo extracting the set of non-visual signals from the metadata. Rather, the computer system can train the model to transform metadata directly into a specification for bitrate-resolution pairs of renditions of the video forecast to fulfill viewership expectations (e.g., minimum playback quality) of a forecast viewership population requesting renditions of the video.

In this implementation, during a later model application phase, the computer implements methods and techniques described above to: access metadata of the target video; and predict viewer population characteristics (e.g., location, count, device characteristics) for the target video. The computer system then injects these values into the model, which returns correlations between: metadata, viewer population characteristics, and requested renditions. Furthermore, the computer system: sets the minimum viewing quality for the target video; and calculates rendition parameters-including count of renditions and their bitrate-resolution values-based on these correlations and the minimum viewing quality of target video. The computer system then: populates an encoding ladder—for the target video—with specifications for renditions in these bitrates and resolutions; and assigns these renditions and their bitrates and resolutions to the target video.

### 9.4 A/B Testing+Machine Learning

In another implementation, the computer system implements A/B testing and regression, machine learning, artificial intelligence, and/or other methods and techniques to generate a model that relates predicted viewer and video characteristics to rendition count, bitrates and resolutions, and viewing quality. The computer system later implements this model to calculate a rendition count, bitrates, and resolutions to achieve a minimum viewing quality for a next inbound video.

In one implementation, during a model generation phase, the computer system can generate two different encoding ladders—specifying different renditions in different bitrates and resolutions—for a single video, such as: a larger count of renditions with tighter clustering of bitrates per resolution in a first encoding ladder; and a small count of renditions with a wider range of bitrates per resolution in a second encoding ladder. The computer system then: assigns the two encoding ladders for the same video to different subpopulations of viewers requesting rendition segments of this video; and encodes mezzanine segments of the video according to renditions specified in both encoding ladders, such as on-demand or just-in-time responsive to rendition segment requests from viewers in both subpopulations.

For example, the computer system can: collect viewership data for the renditions of the video played on devices in both subpopulations; and transform these viewership data into viewing qualities, as described above. The computer system can then derive correlations between viewing qualities and renditions—including rendition count and bitrate-resolution pairs—for the video, such as based on: differences in viewing qualities between these subpopulations; and differences in bitrates and resolutions of renditions in both encoding ladders. The computer system can further associate these correlations with: video entropy values, quantization values, and/or derived characteristics of visual content in the video extrapolated from encoding characteristics (i.e., rather than pixel data), as described above; and viewer subpopulation characteristics (e.g., location, count, device characteristics). The computer system then stores these correlations and associated characteristics in an historical vector (or other “container”). The computer system can then repeat this process over time for other videos to generate a corpus of historical vectors.

In one implementation, the computer system can train (or retrain) the model(s) based on real-time differences in predicted viewing qualities and target viewing qualities. In particular, the computer system can: receive a third target bitrate for the third resolution returned by the third model; calculate a predicted viewing quality associated with the third target bitrate and the third resolution; in response to the predicted viewing quality falling below the first target viewing quality, derive a difference between the predicted viewing quality and the target viewing quality; and, in response to the difference between the predicted viewing quality and the target viewing quality exceeding a threshold difference, implement methods and techniques described herein to receive a second bitrate from a second model.

In the foregoing example, during the first time period, the computer system can then: store the difference between the predicted viewing quality and the target viewing quality in the third model; and retrain the third model according to the difference between the predicted viewing quality and the target viewing quality. Then, during a second time period, the computer system can implement this retrained third model to a new video ingested from the first publisher.

In particular, the computer system can: receive a second video file from the first publisher, the second video file defining a third file size; partially decode the second video file, based on visual characteristics in the second video file, to generate a second proxy video representation of the second video file, the second proxy video representation defining a fourth file size less than the third file size; and derive a second set of entropy characteristics from the second video file, the second set of entropy characteristics representing visual activity in frames of the second video file. Then, for the third resolution in the set of resolutions, the computer system can: access the third model associated with the third resolution; pass the second proxy video representation and the second set of entropy characteristics to the third model; receive a fifth target bitrate for the third resolution returned by the third model and the difference between the predicted viewing quality and the target viewing quality for the first video file; define a fourth rendition for the second video file characterized by the third resolution and fifth target bitrate; and generate a second encoding ladder, associated with the second video file, with the fourth rendition.

Accordingly, the computer system can store real-time deviations from target bitrates (or target qualities), recalculate target bitrates, and later implement these deviations to self-correct outputs in real time.

The computer system then implements regression, machine learning, artificial intelligence, and/or other techniques to train a model to predict correlations between viewing qualities and renditions—including count of renditions and their bitrate-resolution values—based on: video entropy values, quantization values, and/or other derived video characteristics; and viewer population characteristics (e.g., location, count, device characteristics).

During a later model application phase, the computer system receives a video in Block S110 and then implements methods and techniques described above to aggregate: video entropy values, quantization values, and/or other derived characteristics of the target video in Block S120; and predicted viewer population characteristics (e.g., location, count, device characteristics) for the target video in Block S130. The computer system then injects these values into the model, which returns correlations between: viewing qualities; and renditions, including count of renditions and their bitrate-resolution values.

Furthermore, the computer system: sets the minimum viewing quality for the target video in Block S132; and calculates rendition parameters—including count of renditions and their bitrate-resolution values—based on these correlations and the minimum viewing quality of target video.

The computer system then: populates an encoding ladder—for the target video—with specifications for renditions in these bitrates and resolutions; and assigns these renditions and their bitrates and resolutions to the target video.

### 9.5 Deterministic Function

Alternatively, in the foregoing implementation(s), the computer system can compile historical correlations between viewing qualities and renditions for prior videos into a lookup table, represent these correlations in a deterministic function, or store these correlations in any other format.

Upon receipt of the target video, the computer system can implement the foregoing methods and techniques to calculate rendition parameters—including count of renditions and their bitrate-resolution values—based on: the lookup table or deterministic function, etc; the minimum viewing quality for the target video; video entropy values, quantization values, and/or other derived characteristics of the target video; and predicted viewer population characteristics (e.g., location, count, device characteristics) for the target video.

The computer system then: populates an encoding ladder—for the target video—with specifications for renditions in these bitrates and resolutions; and assigns these renditions and their bitrates and resolutions to the target video.

In one implementation, the computer system can compile historical correlations between derived content types and predicted playback environments into a lookup table, represent these correlations in a deterministic function, or store these correlations in any other format.

Upon receipt of the target video, the computer system can implement the foregoing methods and techniques to calculate rendition parameters—including count of renditions and their bitrate-resolution values—based on: the lookup table or deterministic function, etc.; and the predicted viewing environment (e.g., mobile application, high-resolution display) for the target video and derived content type (e.g., videoconferencing recording, lecture slides recording, video containing text, video containing animated graphics, video containing high motion content, social media content).

The computer system then: populates an encoding ladder—for the target video—with specifications for renditions in these bitrates and resolutions; and assigns these renditions and their bitrates and resolutions to the target video.

### 10. Segmentation

Block S150 recites segmenting the video into a set of mezzanine segments. Generally, in Block S150, the computer system can implement methods and techniques described in U.S. patent application Ser. No. 16/458,630 to segment the video into a sequence of mezzanine segments and to queue the mezzanine segments for transcoding according to bitrates and resolutions of renditions specified in the encoding ladder published for the video.

The computer system can also preemptively assign a resource location to each rendition segment queued for transcoding from a mezzanine segment in each rendition selected for the video.

In one implementation, the computer system can segment the video file into mezzanine segments based on scene detection for the video file. In particular, in this implementation, the computer system can: detect a first scene, defined by a first initial keyframe and a first final keyframe, within the first video file in Block S152; define a first mezzanine segment bounded by the first initial keyframe and the first final keyframe in Block S154; detect a second scene, defined by a second initial keyframe and a second final keyframe, within the first video file; define a second mezzanine segment bounded by the second initial keyframe and the second final keyframe; and define a set of mezzanine segments for the first video file, the set of mezzanine segments including the first mezzanine segment and the second mezzanine segment.

In another implementation, the computer system can: detect a first set of frames, defined by a first entropy characteristic in the set of entropy characteristics, within the first video file; define a first mezzanine segment including the first set of frames; detect a second set of frames, defined by a second entropy characteristic in the set of entropy characteristics, within the first video file; define a second mezzanine segment including the second set of frames; and define a set of mezzanine segments for the first video file, the set of mezzanine segments including the first mezzanine segment and the second mezzanine segment.

In another implementation, the computer system can: detect a first set of frames, defined by a first quantization parameter in the set of quantization parameters, within the first video file; define a first mezzanine segment including the first set of frames; detect a second set of frames, defined by a second quantization parameter in the set of quantization parameters, within the first video file; define a second mezzanine segment including the second set of frames; and define a set of mezzanine segments for the first video file, the set of mezzanine segments including the first mezzanine segment and the second mezzanine segment.

In another implementation, the computer system generates mezzanine segments that each include a segment of encoded audio data, a segment of encoded video data, a start time and duration and/or end time of the segment, and a sequence number of the segment such that each mezzanine segment is individually addressable and can be retrieved and transcoded individually from the mezzanine cache.

In yet another implementation, the computer system stores the mezzanine segments in a mezzanine cache. The mezzanine cache stores the mezzanine (e.g., the normalized original video file) in mezzanine segments, which can then be transcoded into rendition segments. In one implementation, the mezzanine version of the ingested video file, stored in the mezzanine cache, can be offered as a rendition version if the ingested version of the video file is satisfactory for streaming. In implementations in which the computer system includes a priming buffer and/or trailing buffer in the encoded audio data of the video segment, these buffer sections of the audio are removed during playback or re-encoded as a shorter segment.

### 11. Encoding Ladder Publication

Block S160 of the method S100 recites generating an encoding ladder specifying: bitrates and resolutions of renditions in the count of renditions; and resource locations of rendition segments transcoded from the set of mezzanine segments in each rendition. Block S170 of the method S100 recites publishing the encoding ladder for the video. Generally, in Blocks S160 and S170, the computer system can: initialize an encoding ladder; populate the encoding ladder with renditions available for the video, including their bitrates and resolutions, as described above; and resource locations of each rendition segment transcoded according to each rendition.

The computer system then publishes the encoding ladder for access by devices requesting playback of the video.

### 12. Transcoding

Block S180 of the method S100 recites transcoding mezzanine segments according to bitrate-resolution pairs of renditions in the count of renditions. Generally, in Block S180, the computer system can implement methods and techniques described in U.S. patent application Ser. No. 16/458,630, which is incorporated herein by this reference, to just-in-time transcode mezzanine segments into rendition segments responsive to requests from devices for these rendition segments.

In one implementation, in response to receiving a first request for a first playback segment of the first video file in the first rendition from a video player, the computer system can: initiate transcoding of the first playback segment, in a set of mezzanine segments of the first video file, into the first rendition by a first worker in Block S180; initiate a first stream of the first playback segment from the first worker to the video player in Block S182; and store the first playback segment in the first rendition in a rendition cache in Block S184.

In one variation, the computer system can: receive a first video including a first mezzanine segment from a live video stream; and receive a second video including a second mezzanine segment from the live video stream. Accordingly, in this variation, the computer system can implement methods and techniques as described herein to just-in-time transcode these mezzanine segments into rendition segments responsive to requests from devices for these rendition segments.

### 13. Audience-Adaptive Encoding

In one variation, the computer system further monitors (or “tracks”) actual viewership data of the video over time, such as views per unit time, viewer location, and/or viewer device type or operating system. If the actual viewership data deviates from the predicted viewership data for the video within this time interval, such as by more than a threshold difference, the computer system can implement methods and techniques described above: to recalculate the minimum viewing quality for the video based on these actual viewership data; and to calculate a new count of renditions and their corresponding bitrate-resolution pairs—such as with bias toward preserving already generated renditions and adding additional renditions with bitrate-resolution pairs around (i.e., distinct from) these extant renditions.

The computer system can then: update and republish the encoding ladder; and selectively transcode mezzanine segments into rendition segments in these new renditions responsive to subsequent requests from viewers.

In particular, in this variation, the computer system can: generate a first encoding ladder based on predicted viewer distribution data (e.g., majority mobile viewers in the US); and subsequently monitor actual viewership metrics in real time, such as by receiving viewership metrics from video players streaming playback segments of the video file.

In one example, the computer system can: detect a deviation of the actual viewership metrics from the predicted viewership metrics (e.g., a proportion of viewers accessing the video file from desktop environments in the set of actual viewership metrics exceeds the expected proportion of viewers in the set of predicted viewership metrics); and, in response to the deviation exceeding a threshold deviation (e.g., 30%, 26% per device type, 20% per network class), recalculate a minimum acceptable viewing quality.

Then, the computer system can: update the encoding ladder to include additional (high-resolution) renditions (e.g., 1440p, 2160p) representing bitrates derived from a model configured to derive target bitrates based on source resolutions and target viewing qualities; and generate additional intermediate bitrate-resolution pairs. For example, the computer system can update the encoding ladder to include a first rendition at 1080p defining a first bitrate and a second rendition at 1080p defining a second bitrate falling below the first bitrate to thereby improve visual adaptability without redundant re-encoding.

14. Mezzanine Segment v. Whole Video

As described above, the computer system can: derive entropy and quantization characteristics of an entire video; predict characteristics of visual content in the entire video; and select rendition count and corresponding bitrate-resolution pairs based on entropy, quantization characteristics, and/or interpreted characteristics of visual content within the entire video. For each rendition, the computer system can then select one codec predicted to yield a maximum compression efficiency for the rendition based on: bitrate and resolution specifications for the rendition; and predicted characteristics of visual content within the entire video. The computer system can then: segment the video into mezzanine segments; and selectively transcode mezzanine segments into rendition segments in particular renditions based on the corresponding codec in response to requests from viewers.

Alternatively, the computer system can implement methods and techniques described above to: segment the video in mezzanine segments; derive entropy and quantization characteristics of each mezzanine segment; and predict characteristics of visual content in each mezzanine segment. The computer system can then: select a count of renditions and corresponding bitrate-resolution pairs for the entire video based on entropy and quantization characteristics of each mezzanine segment; select one codec for each rendition; and selectively transcode these mezzanine segments into rendition segments in particular renditions based on the corresponding codec in response to requests from viewers.

Alternatively, in the foregoing implementation, the computer system can implement hybrid encoding techniques. In particular, for each mezzanine segment in each rendition, the computer system can select one codec predicted to yield maximum compression efficiency for the mezzanine segment in the rendition based on: bitrate and resolution specifications for the rendition; and predicted characteristics of visual content in the mezzanine segment in the rendition. The computer system can then selectively transcode each mezzanine segment based on the codec selected for the mezzanine segment and the particular rendition.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
receiving a first video from a first publisher, the first video characterized by a first file size and a source resolution;
partially decoding the first video, to generate a proxy video representation of the first video, the proxy video representation characterized by a second file size less than the first file size;
selecting a set of resolutions for the first video;
for a first resolution in the set of resolutions:
accessing a first model associated with the first resolution, the first model configured to derive target bitrates based on target viewing qualities;
passing the proxy video representation to the first model; and
receiving a first target bitrate for the first resolution returned by the first model;
for a second resolution in the set of resolutions:
accessing a second model associated with the second resolution, the second model configured to derive target bitrates and target viewing qualities;
passing the proxy video representation to the second model; and
receiving a second target bitrate for the second resolution returned by the second model;
defining a first rendition, for the first video, characterized by the first resolution and the first target bitrate;
defining a second rendition, for the first video, characterized by the second resolution and the second target bitrate;
generating an encoding ladder identifying the first rendition and the second rendition; and
publishing the encoding ladder for access by a set of video players for playback of the first video.

2. The method of claim 1, wherein partially decoding the first video comprises:
deriving a first set of entropy characteristics from the first video, the first set of entropy characteristics representing visual activity between frames of the first video;
selecting a subset of pixels, in frames in the first video, representing the first set of entropy characteristics;
assembling the subset of pixels into a series of proxy frames; and
assembling the subset of proxy frames into the proxy video representation.

3. The method of claim 1:
further comprising accessing a first target viewing quality associated with the first publisher;
wherein accessing the first model comprises:
accessing the first model associated with the first resolution and configured to derive target bitrates based on the first target viewing quality; and
wherein accessing the second model comprises:
accessing the second model associated with the second resolution and configured to derive target bitrates based on the first target viewing quality.

4. The method of claim 1:
further comprising:
for a third resolution in the set of resolutions:
accessing a third model associated with the third resolution, the third model configured to derive target bitrates based on the first target viewing quality;
passing the proxy video representation to the third model; and
receiving a third target bitrate for the third resolution returned by the third model;
calculating a predicted viewing quality of a third rendition of the first video transcoded according to the third target bitrate and the third resolution;
calculating a difference between the predicted viewing quality and the first target viewing quality; and
in response to the predicted viewing quality falling below the first target viewing quality and in response to the difference between the predicted viewing quality and the target viewing quality exceeding a threshold difference:
calculating a fourth bitrate, greater than the third bitrate, based on the difference between the predicted viewing quality and the first target viewing quality; and
defining a fourth rendition, for the first video, characterized by the third resolution and fourth target bitrate; and
wherein generating the encoding ladder comprises generating the encoding ladder further identifying the fourth rendition.

5. The method of claim 1, further comprising:
accessing a corpus of videos published by a population of publishers;
accessing a set of renditions, each rendition in the set of renditions comprising a bitrate-resolution pair, available for the corpus of videos;
for each rendition in the set of renditions, deriving a quality score representing quality of playback for video in the rendition;
for the first model:
selecting a first subset of videos, in the corpus of videos, characterized by the first resolution and quality scores exceeding a first quality score threshold; and
generating the first model based on the first subset of videos; and
for the second model:
selecting a second subset of videos, in the corpus of videos, characterized by the second resolution and quality scores exceeding the first quality score threshold; and
generating the second model based on the second subset of videos.

6. The method of claim 1:
wherein receiving the first video comprises receiving the first video comprising a first mezzanine segment for a first video file;
wherein partially decoding the first video to generate the proxy video representation of the first video comprises partially decoding the first mezzanine segment to generate the proxy video representation of the first mezzanine segment;
further comprising:
receiving a second video comprising a second mezzanine segment for the first video file;
partially decoding the second mezzanine segment to generate a second proxy video representation of the second mezzanine segment;
for the first resolution in the set of resolutions:
passing the second proxy video representation to the first model; and
receiving a third target bitrate for the first resolution returned by the first model;
for the second resolution in the set of resolutions:
passing the second proxy video representation to the second model; and
receiving a fourth target bitrate for the second resolution returned by the second model;
defining a third rendition of the second video based on the first resolution and the third target bitrate; and
defining a fourth rendition of the second video based on the second resolution and the fourth target bitrate; and
wherein generating the encoding ladder comprises generating the encoding ladder identifying the third rendition and the fourth rendition.

7. The method of claim 6:
wherein receiving the first video comprises receiving the first video comprising the first mezzanine segment from a live video stream; and
wherein receiving the second video comprises receiving the second video comprising the second mezzanine segment from the live video stream.

8. The method of claim 6, further comprising:
transcoding the first mezzanine segments into a first rendition segment in the first resolution and the first target bitrate in response to receiving a first request for a first playback segment, corresponding to the first mezzanine segment, in the first rendition; and
transcoding the second mezzanine segments into a second rendition segment in the first resolution and the third target bitrate in response to receiving a second request for a second playback segment, corresponding to the second mezzanine segment, in the third rendition.

9. The method of claim 1, further comprising:
deriving a set of entropy characteristics from the proxy video representation, the set of entropy characteristics representing visual activity between frames for the first video;
interpreting a visual complexity of the first video based on the set of entropy characteristics of the proxy video representation; and
setting a count of resolutions, for the set of resolutions, proportional to the visual complexity of the first video.

10. The method of claim 1, further comprising:
accessing a set of metadata for the first video;
extracting a set of nonvisual characteristics of the first video from the set of metadata;
predicting a viewership count for the first video based on the set of nonvisual characteristics of the first video; and
setting a count of resolutions, for the set of resolutions, proportional to the viewership count.

11. The method of claim 1:
further comprising:
identifying a set of keyframes in the first video, the set of keyframes comprising a first keyframe and a second keyframe; and
for a set of frames between the first keyframe and the second keyframe:
deriving a set of entropy characteristics representing visual activity in frames in the set of frames; and
selecting a set of pixels from the set of frames based on the set of entropy characteristics; and
wherein partially decoding the first video to generate the proxy video representation of the first video comprises generating the proxy video representation comprising the set of pixels.

12. The method of claim 1, further comprising:
accessing a first set of metadata for the first video;
receiving a second video from the first publisher;
accessing a second set of metadata for the second video; and
in response to detecting correspondence between the first set of metadata and the second set of metadata:
generating a second encoding ladder for the second video, the third encoding ladder identifying the first rendition and the second rendition; and
publishing the second encoding ladder for access by video players for playback of the second video.

13. The method of claim 1, further comprising, in response to receiving a first request for a first playback segment of the first video in the first rendition from a video player in the set of video players:
initiating transcoding of a mezzanine segment, in a set of mezzanine segments of the first video, into the first playback segment in the first rendition by a first worker;
releasing the first playback segment from the first worker for distribution to the video player; and
storing the first playback segment in the first rendition in a rendition cache.

14. The method of claim 1, further comprising:
receiving a second video from a second publisher, the second video characterized by a third file size and a second source resolution;
partially decoding the second video to generate a second proxy video representation of the second video, the second proxy video representation characterized by a fourth file size less than the third file size;
accessing a set of historic viewership characteristics for videos published by the second publisher;
predicting a set of viewer characteristics of the second video based on the set of historic viewership characteristics;
deriving a set of target resolutions based on the set of viewer characteristics and the set of resolutions;
for a third resolution in the set of target resolutions:
accessing a third model associated with the third resolution, the third model configured to derive target bitrates based on target viewing qualities;
passing the proxy video representation to the third model; and
receiving a third target bitrate for the third resolution returned by the third model;
defining a third rendition for the second video characterized by the third resolution and the third target bitrate;
generating a second encoding ladder identifying the third rendition for the second video; and
publishing the second encoding ladder for access by the set of video players for playback of the second video.

15. The method of claim 1:
wherein partially decoding the first video comprises:
extracting a set of motion vectors from the first video;
extracting a set of quantization parameters from the first video; and
generating the proxy video representation comprising a feature map representing the set of motion vectors and the set of quantization parameters;
wherein passing the proxy video representation to the first model comprises passing the feature map to the first model; and
wherein passing the proxy video representation to the second model comprises passing the feature map to the second model.

16. A method comprising:
receiving a first video from a first publisher, the first video characterized by a first file size;
deriving a first set of entropy characteristics from the first video, the first set of entropy characteristics representing visual activity in frames of the first video;
partially decoding the first video according to the first set of entropy characteristics to generate a proxy video representation of the first video, the proxy video representation characterized by a second file size less than the first file size;
for a first resolution in a set of resolutions:
accessing a first model associated with the first resolution, the first model configured to derive target bitrates based on target viewing qualities for the first resolution;
passing the proxy video representation to the first model; and
receiving a first target bitrate for the first resolution returned by the first model;
for a second resolution in the set of resolutions:
accessing a second model associated with the second resolution, the second model configured to derive target bitrates based on target viewing qualities for the second resolution;
passing the proxy video representation to the second model; and
receiving a second target bitrate for the second resolution returned by the second model;
defining a first rendition, for the first video, characterized by the first resolution and the first target bitrate;
defining a second rendition, for the first video, characterized by the second resolution and the second target bitrate;
transcoding a first video segment of the first video into a first rendition segment, in the first rendition;
transcoding the first video segment of the first video into a second rendition segment, in the second rendition; and
publishing the first rendition segment and the second rendition segment for access by video players to stream rendition segments of the first video.

17. The method of claim 16:
further comprising:
accessing a target viewing quality associated with the first publisher;
for a third resolution in the set of resolutions, during a first time period:
accessing a third model associated with the third resolution, the third model configured to derive target bitrates based on the target viewing quality;
passing the proxy video representation to the third model; and
receiving a third target bitrate for the third resolution returned by the third model;
calculating a predicted viewing quality of a third rendition characterized by the third target bitrate and the third resolution;
calculating a difference between the predicted viewing quality and the target viewing quality;
in response to the predicted viewing quality falling below the target viewing quality and in response to the difference between the predicted viewing quality and the target viewing quality exceeding a threshold difference:
calculating a fourth bitrate, greater than the third bitrate, based on the difference between the predicted viewing quality and the target viewing quality; and
defining a fourth rendition, for the first video, characterized by the third resolution and fourth target bitrate; and
wherein generating the encoding ladder comprising generating the encoding ladder further identifying the fourth rendition.

18. The method of claim 16:
further comprising:
identifying a set of keyframes in the first video, the set of keyframes comprising a first keyframe and a second keyframe; and
for a set of frames between the first keyframe and the second keyframe, selecting a set of pixels from the set of frames based on the set of entropy characteristics; and
wherein partially decoding the first video to generate the proxy video representation of the first video comprises generating the proxy video representation comprising the set of pixels.

19. The method of claim 16, further comprising:
during a first time period:
accessing a set of historic viewership characteristics for videos published by the first publisher;
predicting a first set of viewer characteristics based on the set of historic viewership characteristics; and
deriving a target viewership quality based on the first set of viewer characteristics; and
during a second time period:
receiving a second set of viewer characteristics from video players streaming playback segments of the first video, the second set of viewer characteristics representing characteristics of playback requests received from video players for the first video;
calculating a first deviation between the second set of viewer characteristics and the first set of viewer characteristics;
in response to the first deviation between the second set of viewer characteristics and the first set of viewer characteristics exceeding a threshold deviation:
for the first resolution in the set of resolutions:
accessing a third model associated with the first resolution, the first model configured to derive target bitrates based on target viewer characteristics;
passing the proxy video representation and the second set of viewer characteristics to the third model; and
receiving a third target bitrate for the first resolution returned by the third model; and
for the second resolution in the set of resolutions:
accessing a fourth model associated with the second resolution, the fourth model configured to derive target bitrates based on target viewer characteristics;
passing the proxy video representation and the second set of viewer characteristics to the fourth model; and
receiving a fourth target bitrate for the second resolution based on the fourth model;
defining a third rendition, for the first video, characterized by the first resolution and the third target bitrate;
defining a fourth rendition, for the first video, characterized by the second resolution and the fourth target bitrate;
replacing the first rendition with the third rendition in the encoding ladder;
replacing the second rendition with the fourth rendition in the encoding ladder;
transcoding a first video segment of the first video into a third rendition segment in the third rendition;
transcoding the first video segment of the first video into a fourth rendition segment in the fourth rendition; and
publishing the third rendition segment and the fourth rendition segment for access by video players to stream rendition segments of the first video.

20. A method comprising, during a first time period:
receiving a first video from a first publisher, the first video characterized by a first file size;
partially decoding the first video, based on visual characteristics in the first video, to generate a proxy video representation of the first video, the proxy video representation characterized by a second file size less than the first file size;
accessing a set of historic viewership characteristics for videos published by the first publisher;
predicting a set of viewer characteristics based on the set of historic viewership characteristics;
deriving a target viewership quality based on the set of viewer characteristics;
selecting a set of resolutions based on the source resolution;
for a first resolution in a set of resolutions:
accessing a first model configured to derive target bitrates based on target resolutions and the target viewing quality;
passing the proxy video representation and the first resolution to the first model; and
receiving a first target bitrate for the first resolution returned by the first model;
for a second resolution in the set of resolutions:
passing the proxy video representation and the second resolution to the first model; and
receiving a second target bitrate for the second resolution returned by the first model;
defining a first rendition, for the first video, characterized by the first resolution and first target bitrate;
defining a second rendition, for the first video, characterized by the second resolution and second target bitrate;
generating an encoding ladder identifying the first rendition and the second rendition; and
publishing the encoding ladder for access by video players to request playback segments of the first video.
